(19) United States
(12) Patent Application Publication
(10) Pub. No.: US 2026/0179111 A1
(43) Pub. Date: Jun. 25, 2026

(54) DIGITAL ADVERTISING SYSTEMS FOR PHYSICAL COMMERCIAL LOCATIONS, AND RELATED METHODS

(71) Applicant: ADSPROUT, INC., Denver, CO (US)

(72) Inventor: Michael Jordan Liss, Denver, CO (US)

(73) Assignee: ADSPROUT, INC., Denver, CO (US)

(21) Appl. No.: 19/541,478

(22) Filed: Feb. 17, 2026

Related U.S. Application Data
(63) Continuation of application No. PCT/US25/45169, filed on Sep. 5, 2025.
(60) Provisional application No. 63/691,764, filed on Sep. 6, 2024.

(51) Int. Cl. G06Q 30/02; G06Q 30/0241; G06Q 30/0242

(52) U.S. Cl. CPC G06Q 30/02; G06Q 30/0243; G06Q 30/0277

(57) ABSTRACT

A digital advertising system for a physical commercial location includes multiple digital displays positioned within store aisles, each display associated with a product category and/or a location zone context. A cloud-based server manages advertisement inventory and performance tracking. The server's auction module receives bids from advertisers and selects winning bids for each display based on its product category and/or location zone context. A performance tracking module applies an econometric attribution method to assign sales uplift to displayed advertisements and an action-based attribution method using tracked shopper actions. The system delivers context-sensitive advertising and provides robust attribution of ad performance within physical retail environments.

### FIELD

This disclosure relates to digital advertising systems for physical commercial locations (e.g., brick-and-mortar retail stores) (also referred to herein as in-store advertising or in-aisle advertising), and to related methods, and, more particularly, to systems and methods directed to an aisle/contextual category implementation (distinct from a sample implementation).

### BACKGROUND

In-store advertising traditionally relies on static, analog displays, or pre-scheduled digital content, and does not account for the real-time context of “shopper intent”. Instead, these systems focus on reaching as many shoppers as possible by placing advertisements in entryways, exit points, or high-traffic areas and attempting to measure the value based on the number of people who see the ads. This focuses on the “top” of the “purchase funnel”, where brands are trying to raise brand awareness without concern for driving decisions when shoppers are in-aisle and choosing what to put in their shopping cart. Some systems may try to gauge performance by tracking sales increases of advertised products in the store location where the advertising was displayed. However, these approaches are generally designed for different advertising purposes and goals, focusing on mass appeal products and brands like Coca-Cola™. They are not effective for specific, niche products, such as lawn mowers, which are infrequently purchased by a smaller subset of the shopping population. This inefficiency results in suboptimal advertising effectiveness and missed revenue opportunities for both retailers and brands. Specifically, retail store aisles have been avoided in most in-store media platforms due to the variation and complexity of trying to advertise within them. Existing systems that do so have not designed automated systems for targeting, measurement, and transacting, which leads to minimal deployment of in-aisle digital advertising systems.

For example, conventional in-store advertising systems and methods cannot deliver ads based on real-time purchase decisions that shoppers are making, at a moment in time. Conventional systems and methods, instead, involve analog advertisements like cardboard “shelf talkers,” or digital screens placed in store entryways, exits, self-checkout kiosks, or aisle end caps. Moreover, conventional systems and methods display content based on predefined schedules, without considering the context of the shoppers or products in their vicinity, and without considering the advertiser who is most willing to reach a shopper in that context and vicinity at that moment in time. Such conventional systems and methods would be akin to Amazon™ selling a sponsored result after a shopper searches “lawn mower” without telling the advertiser that the shopper is shopping for lawnmowers. The value of targeting a shopper who is specifically in the context of shopping for lawnmowers is therefore lost. By contrast, other conventional in-store advertising systems and methods are similar to Amazon™ selling broadly appealing advertisements days or weeks ahead of time for predefined times and prices on their homepage. While such general advertising occurs, it is distinct from the context-specific, targeted advertising that is facilitated on the search results and product pages for lawnmowers. Additionally, market liquidity is an important factor in advertising systems to ensure an efficient marketplace, yet existing systems lack the automation needed to enable a liquid market with dynamic pricing. This limitation not only prevents brands and retailers from transacting at prices that best match their needs, but also results in missed revenue opportunities for both parties.

Efforts have been made to improve conventional in-store advertising systems and methods, yet challenges remain in developing technical steps and solutions to mitigate the deficiencies in the prior art. Therefore, there is a need for improved in-store advertising systems and methods, and for improved digital advertising systems for physical commercial locations.

### SUMMARY

In some aspects, the techniques described herein relate to a digital advertising system for a physical commercial location, including: a. a plurality of digital displays located within aisles of a physical commercial location, each digital display of the plurality of digital displays associated with at least one of: a product category or a location zone context; b. a cloud-based server configured to manage advertisement inventory and performance tracking, the cloud-based server including; i. an auction module configured to: A. receive bids from advertisers for displaying advertisements on the plurality of digital displays; and B. determine a winning bid based on the product category or the location zone context, or both, of a digital display of the plurality of digital displays; and ii. a performance tracking module configured to: A. implement an econometric method for attributing sales to displayed advertisements; and B. implement an action-based attribution method using tracked shopper actions.

In some aspects, the techniques described herein relate to a method for delivering targeted advertisements in aisles of a physical commercial location, including: a. receiving notification that a digital display in a location zone is available for advertising; b. initiating an auction process for an available display by determining relevant advertisements based on at least one of: a product category or a location zone context, derived from planogram data, inventory data, manual input data, or merchandising data, or any combination thereof, c. selecting a winning advertisement based on bid amount and relevance to the product category or the location zone context, or both; d. displaying the winning advertisement on the available display; and e. tracking performance of the winning advertisement using both an econometric method for attributing sales and an action-based attribution method.

In some aspects, the techniques described herein relate to a non-transitory computer-readable medium storing instructions that, when executed by a processor, cause the processor to perform a method for digital advertising in aisles of a physical commercial location, the method including: a. managing an inventory of advertisements for display on digital screens located in aisles of a physical commercial location; b. conducting real-time auctions for available ad space on the digital screens, based on at least one of: a product category or a location zone context, derived from planogram data, inventory data, manual input data, or merchandising data, or any combination thereof, c. delivering winning advertisements to appropriate digital screens; d. tracking advertisement performance using both an econometric method for attributing sales and an action-based attribution method; and e. providing performance analytics to advertisers for optimizing future campaigns.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and examples are merely illustrative of the principles of the present disclosure. Therefore, in the drawings:

FIG. 1 is a simplified block diagram illustration of an example distributed computer network incorporating an example of a system for distributed advertisement management, performance tracking, and real-time bidding across multiple devices, user accounts, user data, sensor data, and the like, utilizing the described event processing techniques, according to the present disclosure.

FIG. 2 is a system diagram illustration of example components and their interactions within the digital advertising system, including the cloud-based server, DB/data lake, advertising management system, optimization engine, auctioning and bidding system, attribution and reporting system, and various client devices, according to the present disclosure.

FIG. 3 is a flowchart of an example auction and advertisement display process, outlining the steps from an in-store display becoming available to the advertisement being shown, according to the present disclosure.

FIG. 4 is a flowchart of an example performance tracking and data flow process, detailing how advertisement traffic and conversion events are logged, processed, and used to calculate advertising performance, according to the present disclosure.

FIG. 5 is a front perspective view of an illustration of an example shelf-mounted tablet and digital display located within an aisle of a physical commercial location, according to the present disclosure.

FIG. 6 is a system diagram illustration of an example product catalog ingestion and management system, according to the present disclosure.

FIG. 7 is a flowchart of an example econometric sales lift process, according to the present disclosure.

FIG. 8 is a flowchart of an example deterministic attribution linkage process, according to the present disclosure.

FIG. 9 is a digital illustration of an example campaign analytics outputs report, according to the present disclosure.

FIG. 10 is a system and process diagram illustration of an example multi-channel advertising strategy or method, according to the present disclosure.

FIG. 11 is a system and process diagram illustration of example advertiser inputs, cloud-based server with an auction module and performance tracking module, in-aisle digital displays associated with product categories or location zone contexts, and performance reports generated from econometric and action-based attribution methods, according to the present disclosure.

FIG. 12 is a flowchart of an example econometric method or process of identifying SKU matches with advertisements, and determining if sales occurred within 2 hours of the advertisement, and calculating attributed sales by subtracting organic sales, according to the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

Moreover, throughout the specification and the claims, the terms “physical commercial location” or “retail stores” or “brick-and-mortar locations” are used for convenience and simplicity and not to limit the scope of the present disclosure. In one aspect, the term “physical commercial location” encompasses any tangible, real-world site where commercial activity is conducted, including but not limited to retail stores, restaurants, service establishments, offices open to customers, shopping centers, malls, kiosks, or other brick-and-mortar venues. The term may further include hybrid environments in which physical premises are augmented with digital or electronic interfaces accessible by customers on-site. A “physical commercial location” or “retail store or location” or “brick-and-mortar store or location or venue” is thus distinguished from purely virtual or online platforms that lack a tangible premises accessible by consumers, but the definition is intended to be interpreted broadly so as to capture a variety of commercial settings where goods and/or services are marketed, displayed, or sold in person.

Moreover, throughout the specification and the claims, the term “planogram data” is used for convenience and simplicity and not to limit the scope of the present disclosure. In one aspect, the term “planogram data” encompasses information, instructions, or digital representations relating to the arrangement, positioning, or display of products within a physical commercial location. Such data may include, for example, schematic layouts, diagrams, or coordinate information specifying shelf placement, product adjacency, orientation, facing counts, or other merchandising directives. The term may further include metadata or rules governing compliance with retailer requirements, inventory management systems, or promotional campaigns. “Planogram data” may be embodied in electronic form, stored or transmitted digitally, or generated dynamically based on sensor input or sales performance, and is not limited to any particular file type, data format, or medium of storage or exchange.

Moreover, throughout the specification and the claims, the term “aisles” is used for convenience and simplicity and not to limit the scope of the present disclosure. In one aspect, the term “aisles” encompasses pathways, corridors, or passageways formed between fixtures, shelving units, displays, or other structures within a physical commercial location. Such aisles may be designated or implied walkways that provide access to products, services, or promotional displays and can vary in width, orientation, or layout depending on the planogram data or merchandising strategy of the location. The term may further include both permanent and temporary aisle structures, including those created by movable racks, endcaps, or promotional displays, and is not restricted to any particular geometric configuration or traffic pattern.

Turning now to the detailed description: Existing in-store advertising systems do not consider the specific decision-making context, habits, preferences, or shopping behavior of individual consumers, nor do they provide performance tracking in real-time. This fails to meet the growing consumer expectation for value-add content when making purchase decisions and personalized experiences based on shopping preferences and intent across all shopping channels, including various physical commercial locations like brick-and-mortar retail stores. By contrast, the disclosed system leverages a digital displays that display digital advertising across various physical commercial locations using aisle category and location zone level targeting, real-time auctions, media buying workflows that mimic online buying workflows, a performance tracking module to produce tracked performance results in near real time for integrated performance reports, and an optimization engine that utilizes performance tracking to optimize ad targeting and delivery in a closed loop system.

Conventional in-store advertising systems and methods are limited in their ability to influence shoppers at the most critical moments of decision-making. Existing approaches generally rely on static signage, analog displays, or pre-scheduled digital content, which are designed to maximize impressions or estimated reach for the purposes of billboard-style advertising rather than deliver targeted messages aligned with shopper context. These systems lack the ability to auction ad space in real time based on shopper context, to adjust dynamically based on shopper behavior, or to provide meaningful sales attribution beyond counts of impressions delivered. As a result, they cannot deliver advertisements that reflect the immediate purchase context of a shopper in a particular aisle or product category. Accordingly, they are unable to capitalize on the value derived from advertising in a retail store such as found when targeting shoppers advertising in online retail sites such Amazon.com or Walmart.com.

Because they are limited to impression-based reporting, conventional in-store advertising systems cannot measure the causal impact of advertisements on sales outcomes. They do not leverage econometric methods for isolating incremental sales effects, nor do they employ deterministic action-based attribution methods that link (directly or indirectly) exposures to shopper behaviors such as coupon redemptions, loyalty identifier matches, QR scans, or point-of-sale receipts. Without these capabilities, conventional systems cannot compute incremental sales lifts tied to displayed advertisements, cannot distinguish new-to-brand purchases, and cannot report auction win rates for aisle-level placements in near real time. This leaves both retailers and advertisers unable to optimize campaigns or assess true return on ad spend.

For example, in one aspect, the disclosed system addresses these deficiencies by providing a programmatic, real-time advertising framework purpose-built for physical retail environments. Digital displays within aisles are programmatically registered to specific product categories and location zones contexts using manual input, planogram data, merchandising data, inventory feeds, and retailer-defined configurations. Advertisers compete for these placements in real-time auctions, ensuring that the winning advertisement is both contextually relevant and optimized for immediate shopper influence.

In another aspect, the disclosed system integrates multiple attribution methodologies to provide a comprehensive view of performance. Econometric methods calculate incremental sales attributable to displayed advertisements by comparing observed outcomes against historical baselines or control groups. Deterministic, action-based attribution directly correlates tracked shopper actions to specific exposures by joining impression logs with redemption events, loyalty identifiers, or purchase receipts within retailer-defined attribution windows. Together, these attribution techniques enable granular, causal measurement of advertisement effectiveness, producing metrics such as incremental sales lifts, attributed units, redemptions, new-to-brand sales, and auction win rates.

In another aspect, by unifying these capabilities, the disclosed system closes the gap between online advertising precision and measurability with the historically limited in-store advertising environment. It brings real-time auctions, contextual targeting, and robust attribution to the physical retail store, enabling advertisers and retailers to maximize campaign efficiency, optimize spend, and create measurable value at the point of purchase with the same precision.

Conventional in-store advertising typically operates at the top of the purchase funnel, focusing on broad reach and general brand awareness through static displays or pre-scheduled digital content sold in pre-determined deals with a defined start and end time. These methods aim to influence a shopper's long-term perception of a brand, often when the shopper is not simultaneously browsing products or in a position to make an immediate purchasing decision.

Static displays may include cardboard product holders, floor stickers, paper posters, shelf-edge paper labels with printed media, and similar materials. These displays are generally sold through long-term agreements that require significant advance planning and setup, and they are difficult to measure accurately due to the absence of digital attribution methods.

Digital displays may include televisions, endcap displays, floor-standing displays, and in-aisle displays. In some cases, such digital placements may be sold through programmatic or real-time auctions for available ad space; however, such auctions are typically limited to generalized location zones that are not directly tied to the shopper's immediate purchase context. These generalized zones may include entryways, checkout lanes, deli waiting areas, pharmacy waiting areas, or other broad environments, rather than the aisle-level or product category context that is most relevant to an imminent purchase decision.

However, as shoppers move further down the purchase funnel, the need for targeted, contextually relevant advertising becomes more pronounced. The bottom of the purchase funnel represents the point of decision, where shoppers are closer to making a purchase. Online, this occurs when shoppers are engaging with specific product search results, browsing product detail pages, or navigating categorized pages. In physical retail, this occurs when shoppers are walking through categorized store aisles and actively evaluating which products to place in their cart. It is at this stage that advertising has the most potential to directly influence a shopper's choice of brand or product.

The success of Amazon Ads™ and other online retail media networks illustrates the power of advertising at the point of decision. Unfortunately, conventional in-store advertising methods fall short in this regard. Despite brick-and-mortar stores housing the same point of decision as online shopping, no digital advertising system has been built to seamlessly monetize this moment in the same way. Cardboard displays, floor stickers, and other static advertising methods lack the information density and engagement potential of digital advertising, particularly video advertisements. These static methods are also difficult to measure accurately with econometric methods for sales attribution or performance lift, and they are not bought or sold in a real-time, liquid market as online advertising is.

Likewise, most digital displays in stores are not positioned within aisles, are not targeted in real time using product category or location zone context, do not employ an auction module to create market liquidity, and do not use econometric or action-based models to measure sales impact. While certain systems may incorporate one or two of these elements, no existing solution combines them into a single, automated advertising system that integrates targeting, buying, and measurement with the explicit purpose of providing an in-store advertising framework analogous to online retail media advertising platforms. Conventional in-store systems also lack advanced econometric methods or action-based attribution models capable of isolating the incremental sales caused by advertising in the same way that occurs online. As a result, these systems cannot deliver personalized advertisements based on real-time purchase context or shopper decision-making at the aisle level. This leads to missed opportunities to influence shoppers at the exact moment of decision and to convert purchase intent into attributable sales.

Moreover, conventional in-store advertising systems do not utilize causal performance tracking, which is crucial for measuring the direct impact of advertisements on sales outcomes. Without the ability to measure the causal impact of advertising on sales, retailers and brands cannot accurately gauge the effectiveness of their advertising efforts or optimize their strategies accordingly. Additionally, action-based attribution provides a deterministic measurement of sales impact that are absent from conventional in-store systems. This inefficiency drives wasted advertising spend by preventing advertisers from accurately identifying which strategies are delivering positive results and which are underperforming.

To fully capitalize on the influence of advertising at the bottom of the purchase funnel—capturing shopper intent at the point of decision—there is a need for systems that can adapt to the real-time context of shopper intent and deliver targeted advertisements at the point of decision. Such systems would allow retailers and brands to dynamically engage shoppers, similar to how online platforms adjust sponsored search results based on current searches, thereby maximizing the impact of their marketing efforts and driving higher conversion rates. For example, dog toy manufacturers can cross-promote their new dog treat dispensers in the dog treats aisle. Or, frozen dog food manufacturers can conquest for traditionally kibble purchasing customers by choosing to advertise to shoppers currently browsing the kibble aisle by advertising in the kibble dog food aisle. Such systems would also provide increased liquidity to the advertising marketplace by allowing minute-by-minute adjustments to advertising bids and purchases and optimize advertising content based on what content is driving the most sales. For example, if kibble buyers are stubborn and the frozen dog food manufacturer does not see satisfactory performance from the kibble aisle, they may choose to automatically pause their advertising campaign and re-allocate those resources to a different campaign strategy. By bridging the gap between top-of-the-funnel brand awareness and bottom-of-the-funnel purchase intent, advanced in-store advertising solutions can create more meaningful connections with shoppers and significantly enhance both the shopper experience and the overall effectiveness of advertising investments.

As such, systems and methods according to the present disclosure address the limitations and deficiencies in the prior art and, in one aspect, introduce a programmatic approach to in-store advertising that promote successful targeted advertisements for specific store aisle or contextual categories, such as “Organic Dog Treats”, “Men's Health and Supplements” and “Women's Clothing and Apparel”, etc. These systems utilize a combination of data sources and technologies to target real-time shopper intent and enable highly targeted advertising placement.

In another aspect, the system facilitates targeted advertising by allowing advertising campaigns to bid on specific aisle categories, such as “Organic Dog Treats,” to secure ad placement on digital screens that are registered and strategically placed within those aisles. This bidding process enables advertisers to compete for the opportunity to display their ads directly where relevant products are located, ensuring that advertisements are contextually aligned with the products immediately available for purchase. For example, digital screens placed in the organic dog treats aisle will feature ads from advertisers who have successfully bid for that specific category, promoting organic dog treats and related pet products. This targeted approach maximizes the relevance and effectiveness of in-store advertising by aligning promotional content with the shopper's immediate context and likely interests, enhancing the likelihood of influencing purchasing decisions and maximizing cost efficiency and return on investment for advertisers. Eligibility can also be defined at a product category level or at a more general location zone context level, such as “Deli Counter” or “Beverages End Cap”, enabling the system to enable dynamic adjustment of bids and ad content based on performance data at a product category level or at a location zone context level.

In another aspect, systems and methods according to the present disclosure can incorporate cameras to detect the number of shoppers in a given area. By analyzing foot traffic patterns and shopper density, these systems can determine optimal times for ad placement, thereby maximizing exposure and engagement. For instance, during peak shopping hours, the system might prioritize advertisements that have been shown to generate higher engagement rates, dynamically adjusting ad content based on real-time shopper activity. Additionally, person-detection technology can be used to identify and count the number of shoppers who have been exposed to a specific advertisement, providing a more accurate measurement of actual reach. This capability enhances the precision of performance metrics by moving beyond estimated impressions to verifiable shopper counts, enabling advertisers and retailers to better evaluate campaign effectiveness and optimize future placements.

Moreover, in another aspect, systems and methods according to the present disclosure can be augmented with app connectivity to deliver a personalized shopping experience. Through the integration of mobile apps, these systems can identify individual shoppers, reference their historical shopping data, and deliver personalized promotions or advertisements. For example, a shopper identified via their smartphone app as a frequent purchaser of a specific brand could receive tailored promotions for that brand upon entering the relevant aisle. This personalized approach not only enhances the shopping experience for consumers but also increases the effectiveness of advertisements by directly aligning them with the known preferences and behaviors of individual shoppers.

Furthermore, in another aspect, systems and methods according to the present disclosure provide an integrated solution that enhances both general and personalized targeting capabilities. By leveraging real-time shopper data and advertising performance results, these systems bridge the gap between traditional in-store advertising and the data-driven, real-time optimization standards of digital marketing, meeting the evolving demands of both advertisers and consumers in the modern retail environment. The system may further generate advertising performance results from these interactions, including engagement rates, incremental sales lift, and return on ad spend (ROAS), which feed into unified reports for campaign optimization.

In another aspect, these advertising performance results include standardized advertisement performance metrics for online retail media, enabling consistent reporting across retail media platforms and enhancing integration with external media platforms.

In another aspect, Central to the functionality of this system is a real-time ad auction mechanism, which provides liquidity to the advertising market. This mechanism is executed as real-time auctions for each digital display opportunity defined in units of time, ranking relevant advertisements based on granular aisle-level product category and location zone context and all associated campaign targeting parameters. Unlike conventional systems that rely on generalized placements on large screens in high-traffic areas such as entryways, delis, or pharmacy waiting zones, the disclosed system additionally enables advertising directly at the crucial point of purchase within the shopping aisle itself, at scale. Advertisers can bid for ad space on a moment-to-moment basis, allowing for flexible spending that aligns with their marketing budgets and goals and do so with a system that can manage hundreds, or thousands, of available product categories to target automatically and without the need to add manual operations and staff to manage categories.

In another aspect, the system further incorporates an automated category management framework that leverages point-of-sale (POS) data, manual input, planogram inputs, and retailer-defined configurations to dynamically create, update, and manage available product categories. These product categories are then manually or automatically paired with the digital displays that have been mapped to the same categories or location zones, allowing the auction module to allocate and price impressions based on real-time contextual relevance. This automation, powered by artificial intelligence, unlocks the ability to execute granular category-level targeting across thousands of screens and categories at scale without the manual effort required to manage hundreds or thousands of locations, a capability that has not been demonstrated in conventional in-store advertising systems.

In another aspect, by combining granular targeting with automated category management, the disclosed system eliminates the need for large spend minimums and cumbersome manual sales processes characteristic of current digital display systems. Instead, advertisers participate in a dynamic marketplace where bids are continuously optimized based on shopper engagement, incremental sales lift, and tracked performance data, enabling precise targeting at the point of decision within the aisle.

In another aspect, systems and methods according to the present disclosure also provide for real-time performance measurements. Measurements such as sales lift, shopper interactions, offer scans and redemptions, ad impressions, and new-to-brand sales lift, the system can offer detailed insights into the effectiveness of specific advertisements. Retailers and brands can use this data to refine their advertising strategies, adjusting in-flight campaign configurations such as copy, image/video/audio creative, targeted aisle categories or audiences, targeted retailers or locations or geographies, in real-time in order to optimize advertising spend against advertising goals.

In another aspect, advertisements can be dynamically matched to store locations where the advertised products or brands are actively stocked and sold, as verified by recent point-of-sale (POS) data. This capability ensures that advertising spend is directed toward environments where shoppers can immediately act on the message, thereby optimizing conversions and return on investment.

In yet another aspect, systems and methods according to the present disclosure can incorporate planogram data, point of sale data, and merchandising data as sources for defining product categories and location zone context. Associations between screens and products may be reinforced through manual input data and location metadata, ensuring the association between the digital display and at least one product category remains accurate as stores update. The system maintains an association between each display and its product category and location zone context, derived from planogram data, inventory feeds, manual mapping, and retailer-defined configurations, with such association being managed manually or automatically, or any combination thereof, and adjusted for other contextual factors such as seasonal resets. These data inputs allow a retailer to align the association of digital displays with the correct contextual categories of products and store layout.

In another aspect, POS data is further leveraged to validate that advertisements are only delivered in locations where the promoted products or brands are currently available for purchase. For example, a retailer-defined configuration may specify that a display located at the end of an aisle corresponds to a promotional zone for beverages. By leveraging these diverse data sources, the digital advertising system can dynamically adapt to changing inventory availability, store layout modifications, and evolving product placement decisions. Such contextual factors ensure that advertisements remain highly relevant and effective at influencing in-aisle purchase behavior.

In yet another aspect, systems and methods according to the present disclosure can incorporate planogram data, manual input data, point of sale data, and merchandising data as sources for defining product categories and location zone context. These data inputs allow a retailer to align the association of digital displays with the correct contextual categories of products and store layout. For example, a retailer-defined configuration may specify that a display located at the end of an aisle corresponds to a promotional zone for beverages. By leveraging these diverse data sources, the digital advertising system can dynamically adapt to changing inventory availability, store layout modifications, and evolving product placement decisions. Such contextual factors ensure that advertisements remain highly relevant and effective at influencing in-aisle purchase behavior.

In another aspect, the optimization engine leverages a combination of algorithms and rules for advertisement selection, continuously refining delivery decisions based on historical performance data and tracked shopper actions. For instance, the engine may analyze incremental sales lift and measure engagement rates across various locations, creatives, products, brands, time of day, and POS-confirmed availability of advertised products or brands at specific store locations, etc.

In another aspect, the optimization engine applies artificial intelligence and machine learning techniques to refine outcomes, leveraging historical performance data in conjunction with tracked shopper behavior. The optimization engine also records tracked performance results and auction win rates by aisle and location zone, then recommends optimizing future auction bids and creative variants based on this feedback. The engine incorporates process algorithms and rules in combination with artificial intelligence and machine learning techniques, enabling adaptive decisioning and predictive accuracy for ad delivery. Using these insights, the optimization engine dynamically modifies advertisement selection criteria and allocates bids accordingly. The inclusion of both econometric and action-based attribution metrics ensures that the optimization engine accounts for multiple perspectives on advertising effectiveness. This comprehensive process enables advertisers to rely on a consistent decision-making framework that enhances long-term performance across channels.

In another aspect, the system integrates campaign creation, management, and measurement from external advertising platforms and other advertising channels, such as online retail media, streaming video, search advertising, social media, or loyalty apps, enabling advertisers to generate comprehensive, cross-channel campaigns measured with unified performance metrics. These advertising performance results metrics may include total reach across multiple advertising channels, attributed conversion rates accounting for different mediums and exposure along the purchase journey, and comparative return on ad spend (ROAS) for various advertising channels. Unified analytics can be provided through a web application interface, which allows advertisers to view holistic performance reports across campaigns, compare tracked performance against external performance data, and assess the efficacy of multi-channel advertising strategies. Customer journey analysis can incorporate interactions at aisle-level product category touchpoints, providing advertisers with a more complete understanding of how shoppers engage with advertisements before completing a purchase. By combining this external performance data with in-store tracked performance, the system delivers insights into advertising effectiveness across different advertising environments, ensuring advertisers can optimize campaigns based on unified, omnichannel intelligence.

In another aspect, the system may employ an auction module to determine the winning advertisement for a particular available display. The auction process can incorporate bid price, contextual relevance to the registered aisle category, inventory availability, submitted auction bids and applies process algorithms and rules in combination with retailer-defined configurations to determine the winning advertisement. For instance, in the robot vacuum aisle, the available display mounted on shelving can participate in an auction process where advertisers for multiple brands compete for placement, ensuring the winning advertisement is both relevant and optimized for shopper impact.

In another aspect, the system enables retailers to enforce brand safety and adjacency rules when advertisers create campaigns. For instance, a retailer may prevent direct competitors such as Coca-Cola® and Pepsi® from appearing sequentially on the same display. In another example, a retailer may require prior approval of creative assets to ensure compliance with merchandising strategies or health regulations. These approval workflows are built into the campaign creation process, ensuring that advertiser submissions are screened before becoming eligible for auction participation.

In another aspect, comprehensive analytics can be generated to unify tracked performance with external performance data from advertising platforms. The reporting suite supports comprehensive analytics that span multiple advertising channels. These analytics rely on comparing performance data, integrating performance data, and combining performance data from diverse sources to produce a holistic view of advertising effectiveness. These unified performance metrics can be presented in holistic performance reports, highlighting multiple advertising efforts across in-store and online channels. Such reports may include return on ad spend (ROAS) comparisons, engagement rates, customer journey analysis with aisle-level touchpoints, and the overall efficacy of campaigns across advertising environments. Such reports may also consolidate advertising performance results from in-store and online data, ensuring that comprehensive analytics reflect both tracked actions and broader campaign outcomes.

In another aspect, product merchandising data may be incorporated into advertisement selection, allowing campaigns to reflect real-time planogram configurations, shelf placement, and promotional signage. Additional contextual inputs may include automated detection methods and location metadata, which together inform contextual factors such as inventory availability and seasonal resets. This integration ensures that ad content aligns with current product placement and store layout, providing a holistic view of merchandising and advertising effectiveness. Inventory availability and retailer-defined configurations can further determine whether particular advertisements are served on displays registered to specific locations.

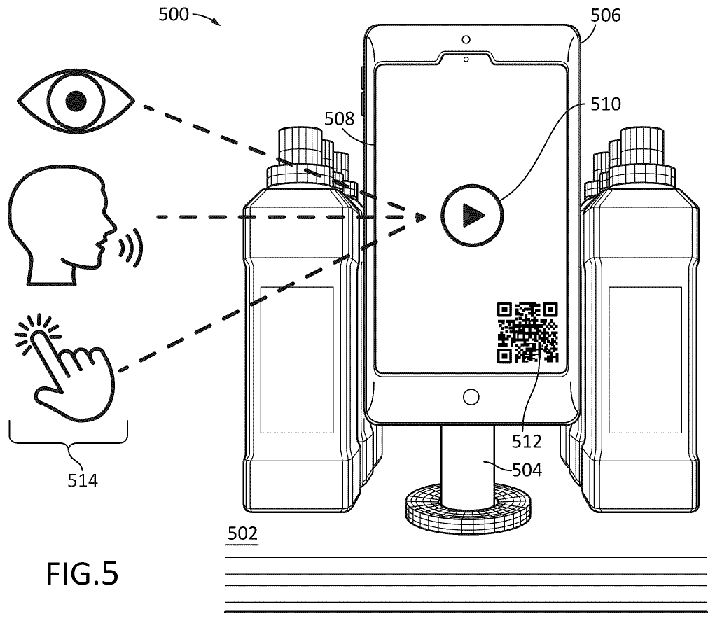

In another aspect, the disclosure contemplates physical embodiments such as a digital display of a tablet mounted within a bespoke enclosure and secured to store shelving or pegboard in a store aisle using screw points or faceplate configurations. For example, a Lenovo M8 or similar device can be mounted using a bracket as illustrated in FIG. 5 and described in detail herein. The mounted tablet represents the available display for that aisle, registered to a specific product category such as robot vacuums. This configuration ensures that advertisements delivered on the device are contextually aligned with the products in that aisle, supporting dynamic adjustment of campaigns, product demonstrations, navigation directions, and delivery of detailed product information within the store layout.

### I. Example Use Case Scenarios

Systems and methods according to the present disclosure present a novel approach, and one or more technical steps and solutions, to addressing the challenges and deficiencies in the prior art.

For example, in one aspect, systems and methods according to the present disclosure allow for “programmatically purchased” digital advertisements, at brick-and-mortar retail stores, and allow for “ad targeting” and “performance measurement” by enabling granular, real-time advertising at precise, high-impact physical commercial locations for high-intent shoppers, and allow for data-driven optimization of advertising campaigns within the retail store environment. Advertisers can bid on specific aisle categories or contextual settings (e.g., “Organic Dog Treats”, “Local Craft Beer”, “Revlon”, “Deli Area”) to secure ad placement on digital screens registered within the vicinity of those products, aisle categories, or contexts. For instance, in the organic dog treats aisle, only advertisements from brands that bid successfully on this category are displayed, ensuring relevance and maximizing the potential impact of the ad.

In another aspect, systems and methods according to the present disclosure can be integrated with existing online advertising platforms, allowing advertisers to run cohesive campaigns across both digital and physical spaces, and allowing for direct comparison and optimization of ad performance across channels. For example, a retailer might use a unified dashboard to manage ads across Google, Facebook, and in-store digital displays, using APIs to share and synchronize ad content and ingest performance results. This integration allows for direct comparison, measurement, and optimization of ad performance across channels. Attribution algorithms can be developed to ingest delivery, shopper engagement, and performance results data in order to understand the impact and value of purchased advertisements along the purchase funnel. A campaign might start with online ads, follow with retargeting ads on streaming TV, and culminate in a personalized in-store ad and offer, with engagement and performance data collected at each stage.

In another aspect, systems and methods according to the present disclosure enables advertisers to create unified, omnichannel campaigns that can influence both in-store and online purchases while creating more sales for retailers and brands. These systems allow for the integration of in-store advertisements with online promotional offers. For example, if a retailer carries robot vacuums in their physical stores but offers robot mops through their online store, an advertiser can create a combined campaign that targets both channels. When a shopper is in the store and considering the purchase of a robot vacuum, a digital screen could display an advertisement offering a special promotion: purchase a robot vacuum in-store today and receive a discount on a robot mop purchased online within the next 30 days.

In another aspect, systems and methods according to the present disclosure enable advertisers to create unified, omnichannel campaigns that deliver consistent messaging to consumers, whether they are engaging online or interacting in-store. These systems facilitate the integration of in-store advertisements with online calls-to-action, such as signing up for a newsletter or downloading a mobile app, thereby providing a way to digitally market for online services and products, particularly for online services and products that are relevant to the screen context. For example, when a shopper is browsing the antacids aisle in a drugstore, a digital screen can display an advertisement encouraging them to sign up for a new health app that aims to naturally reduce indigestion with behavioral change.

In another aspect, systems and methods according to the present disclosure leverage system processes including: receiving bids from advertisers, to display ads on digital screens, within various physical commercial locations; selecting the winning bids based on real-time factors, such as geospatial store location, aisle category, and in-stock inventory; and dynamically adjusting ad content and targeting based on immediate in-store context (much like how online ads adapt to user behavior). For example, if multiple brands bid on ad space in the beverage aisle, the system can prioritize ads for products currently in stock and align with current shopper profiles detected via app connectivity or camera analytics. This ensures ads are relevant and effective, much like how online ads adapt to user behavior in real time.

In another aspect, systems and methods according to the present disclosure utilize advanced performance tracking capabilities, and econometric-based attribution methods and action-based attribution methods, to yield metrics for in-store advertising that are analogous to those used in online advertising, enabling a comprehensive understanding of ad effectiveness. The time-based attribution method applies universally to all ads, allowing for consistent measurement of incremental sales by comparing sales data within defined timeframes after an ad is displayed to historical sales baselines. This approach ensures broad applicability and can be used to measure the impact of all advertisements, regardless of whether they include an available action.

In another aspect, systems and methods according to the present disclosure utilize advanced performance tracking capabilities, including econometric attribution methods based on causal inference and action-based attribution methods, to yield specific metrics for in-store advertising that are directly analogous to those used in online advertising platforms. These metrics may include incremental sales lift, attributed units sold, cost-per-purchase, return on ad spend (ROAS), advertising cost of sales (ACOS), engagement rates, coupon redemptions, and new-to-brand sales. Each of these metrics has a direct online analog: for example, incremental sales lift corresponds to online conversion lift studies, attributed units and cost-per-purchase mirror “conversions” and “cost-per-acquisition” (CPA) in platforms such as Google Ads™, and new-to-brand sales directly align with Amazon Ads™ new-to-brand reporting.

The econometric method applies universally to all advertisements, allowing for consistent measurement of incremental sales by applying causal inference techniques to sales data within defined timeframes after an advertisement is displayed, and comparing against historical baselines or control stores. This ensures broad applicability and enables causal measurement of all advertisements, regardless of whether they include a trackable action. The action-based attribution method supplements this by providing deterministic linkage between exposures and tracked shopper actions, such as coupon redemptions, QR scans, loyalty identifier matches, or point-of-sale receipts, thereby mirroring last-click or view-through attribution models in online environments.

As used herein, the term “comprehensive” refers to the ability of the disclosed system to measure both advertisement exposures (who viewed the advertisements) and the resulting impact of those advertisements on sales outcomes. Because the system is able to capture and attribute sales impact in a manner consistent with online advertising platforms and utilize unique shopper-level loyalty identifiers, these in-store results can be combined with online impression and sales data to provide a unified data set for cross-channel measurement. In this way, advertisers are able to conduct comprehensive performance analysis across multiple environments, including in-store retail media, online retail media, connected television, and other digital advertising platforms.

In another aspect, systems and methods according to the present disclosure leverage an econometric method that calculates incremental sales attributed to the ad display times, for example, by analyzing sales data from the retail store's point-of-sale (POS) system and comparing to historical baseline averages when similar advertisements or digital content were displayed and not displayed. For example, the system identifies SKU matches with ads displayed and calculates incremental sales based on purchases made while, or shortly after, an ad was shown. An action-based method tracks sales by correlating tracked shopper actions, like scanning a coupon displayed on the screen and then using that coupon at checkout or interacting with the screen itself. This provides a direct link between ad exposure and shopper behavior, enabling precise attribution.

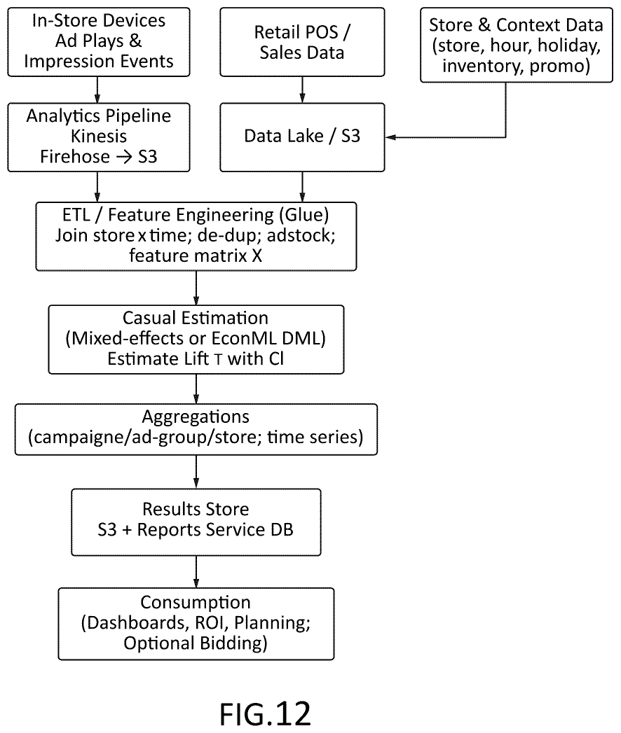

In another aspect, systems and methods according to the present disclosure leverage an econometric method or process of identifying SKU matches with advertisements, and determining if sales occurred within 2 hours of the advertisement, and calculating attributed sales by subtracting organic sales (as illustrated in FIG. 12).

In another aspect, still referencing the above image, systems and methods according to the present disclosure leverage an econometric-based method or process involving analyzing sales data from a retail store's point-of-sale (POS) system.

In another aspect, systems and methods according to the present disclosure leverage an action-based method that tracks shopper engagement using tracked shopper actions such as, for example, coupon scanning or clicking, or taking other relevant actions, providing a direct correlation between ad exposure and shopper engagement.

In another aspect, systems and methods according to the present disclosure leverage an action-based method that tracks shopper engagement using tracked shopper actions such as scanning an offer on the screen, clicking on the screen itself, or taking other relevant actions.

In another aspect, systems and methods according to the present disclosure leverage an action-based method or process for matching sales data with advertisements and coupons used in the past 30 days to count attributed sales.

In another aspect, systems and methods according to the present disclosure leverage an action-based method that uses offer codes to track sales. It looks at offer codes used on purchases and checks for either matching offer code scans or offer codes displayed in an ad within the past 30 days. This allows tracking of purchases made using these codes, whether directly scanned or resulting from ad displays. This provides a direct correlation between a shopper seeing an ad and then purchasing based on that ad.

In another aspect, systems and methods according to the present disclosure leverage artificial intelligence (AI) and machine learning (ML) to optimize auctions and bids, and to improve the selection process and enhance ad relevance. Moreover, in another aspect, the AI and/or ML are leveraged to analyze shopper behavior data and shopper history data received from retailers, for example, and or to personalize and target ads when a shopper approaches a screen.

In another aspect, systems and methods according to the present disclosure utilize machine learning (ML) and artificial intelligence (AI) to analyze historical bidding data to optimize bid prices and targeting criteria for specific brands and products. By examining past bidding behavior and ad engagement patterns, the system can recommend adjustments to bid strategies. For instance, the system might suggest increasing bids by 20% for high-traffic, high-engagement areas like the painkiller aisle, where targeted ads have historically driven significant sales. Conversely, the system may recommend decreasing bids in low-engagement zones such as general context areas like the pharmacy waiting area, where ads have shown less impact. This data-driven approach helps advertisers allocate their budgets more efficiently, maximizing return on investment.

In another aspect, systems and methods according to the present disclosure leverage AI to enhance advertisement selection by continuously testing different ad creatives and content variations. The system uses AI algorithms to analyze real-time performance data, determining which ads are generating the highest engagement and conversion rates. Based on this analysis, the system can automatically shift ad delivery towards better-performing creatives, ensuring that the most effective content is displayed to shoppers. For example, if two different ads are being tested for a new pain relief product, and one shows a higher engagement rate, the system will allocate more display time and winning bids to the successful ad. This adaptive capability allows for dynamic optimization of ad content, leading to improved ad effectiveness and higher sales.

In another aspect, systems and methods according to the present disclosure employ AI and large language models (LLMs) to assist in generating optimal ad content, thereby reducing the time, cost, and effort required to create advertising campaigns. By analyzing successful ad campaigns and leveraging natural language processing capabilities, the system can suggest ad copy, imagery, and promotional strategies tailored to specific products, brands, and target audiences. For example, the system might recommend specific messaging for a new skincare product based on the performance of similar past campaigns and current market trends. This functionality not only lowers the burden on advertisers but also accelerates the time-to-market for new ad campaigns, allowing brands to respond quickly to changing consumer demands and market conditions.

In another aspect, systems and methods according to the present disclosure include a bidding system that allows advertisers to bid on ad display opportunities, wherein winning bids are determined through an auction process, and wherein advertisers specify maximum bids and targeting preferences such as geography, intended audience or shopper type, aisle categories, retailers, and wherein the auction mechanism considers bid amount, target audience relevance, shopper behavior data, geography, aisle categories, and other factors to determine the winning ad.

In another aspect, systems and methods according to the present disclosure support selling advertisement slots for a specified period and location without using an auction process, wherein advertisers can purchase these slots directly, allowing for predetermined ad placements based on time and store location.

In another aspect, systems and methods according to the present disclosure are configured to integrate performance data from in-store digital displays with performance data from other advertising channels, allowing for the generation of comprehensive, cross-channel performance metrics, and providing unified analytics that enable advertisers to compare and optimize performance across various advertising channels.

In another aspect, systems and methods according to the present disclosure are capable of generating, processing, storing, managing, and delivering digital offerings to enhance and customize the shopping and digital offer experience for consumers.

In another aspect, systems and methods according to the present disclosure are capable of improving the ability of retailers and product manufacturers, offer distributors, and retailers, to customize digital advertising and offer selection, delivery, utilization, management, monetization, and redemption, thus increasing the efficiency and financial return of the digital advertising within various physical commercial locations.

In another aspect, a shopper enters the pet food aisle of a retail store where a digital display is registered to the “Organic Dog Treats” product category. The digital display is configured to auction itself every 60 minutes to the highest bidding campaign. Within the past hour, the display sent an auction request. The auction module receives bids from multiple advertisers, and Brand A's advertisement wins the auction based on bid value, POS-confirmed availability, and campaign targeting parameters including product category as “Organic Dog Treats”. The advertisement is displayed as a video creative, and the shopper scans a QR code that opens a redeemable discount in the retailers app. The system uses facial and gaze detection to record the impression. The scan action is recorded with the unique QR code identifier created for the unique ad display and auction win and the shopper's loyalty ID captured from the retailer app. The subsequent purchase at checkout is also logged by the retailer with the shopper's loyalty ID, enabling action-based attribution to deterministically link the ad exposure to the sale using the unique QR code associated to the shopper loyalty ID upon scan which is then associated to the loyalty ID during the purchase at checkout. The econometric method simultaneously measures incremental lift by comparing sales outcomes to a control store where the ad was not shown.

In another aspect, a shopper in the beverage aisle encounters a digital endcap screen that serves as part of a campaign for soft drinks. When the screen becomes available, the auction module ranks bids for cola brands. The winning brand's advertisement is displayed, and the shopper selects that product in the aisle. Incremental sales lift is estimated using an econometric method based on causal inference (e.g., difference-in-differences, synthetic controls, or propensity-score-matched controls), with machine-learning models to adjust for confounders (such as promotions, pricing, inventory, seasonality, store traffic, and daypart) and to estimate heterogeneous treatment effects across stores and screens. This causal-inference framework replaces simple pre/post comparisons and provides a robust measure of advertisement effectiveness for impulse categories like beverages.

In another aspect, a shopper interacts with an AI-powered assistant on the in-aisle display. The shopper asks for product recommendations (e.g., “What's the best option for sensitive skin laundry detergent?”). The assistant responds with personalized recommendations drawn from POS and product data. Sponsored recommendations are eligible to appear in the results through the auction module, ensuring that advertisers can bid for visibility within the AI assistant's responses. Shopper interactions, such as tapping a recommended product or scanning a coupon, are logged as tracked shopper actions for attribution.

In another aspect, the system extends beyond the aisle to dynamically target billboards located just outside retail stores. For instance, a digital billboard near a grocery store entrance may be targeted with “Back to School Snacks” advertisements only if POS data confirms inventory availability in that store. This solves a common limitation of conventional billboard advertising, which often promotes products that may not be in stock at the associated commercial location. The system's ability to connect POS data with external displays ensures outdoor campaigns remain contextually relevant and immediately actionable.

In another aspect, the system enables coordinated cross-promotion between aisles. For instance, a shopper browsing the “Pasta” aisle might see a contextual advertisement for pasta sauce, or a shopper in the “Beer” aisle may be shown promotions for chips or snack foods. The auction module can be configured to treat related aisle categories as linked, allowing advertisers to bid across multiple categories for common cross-promotion opportunities. Shopper engagement and purchases in both aisles are attributed through econometric and action-based methods, demonstrating incremental lift from cross-category targeting.

In another aspect, a brand advertiser submits a campaign targeting the “Lawn Mowers” product category. The advertiser uploads creative assets and targeting parameters, which are automatically routed through the brand control and pre-approval framework. The retailer's merchandising team reviews the creative for compliance with brand safety guidelines, competitive adjacency rules, and store strategy requirements. Only after approval is the campaign made eligible for auction. When the campaign is live, the system enforces competitive adjacency rules to prevent two direct competitors (e.g., Brand A and Brand B) from running back-to-back advertisements on the same in-aisle screen within a defined time window. The advertiser then receives reporting metrics including incremental sales lift, attributed units, and ROAS, analogous to keyword-based reporting in online retail media platforms. This example illustrates how the disclosed system protects retailer and brand interests while enabling advertisers to programmatically target precise product categories at the point of purchase.

In another aspect, a shopper enrolled in the retailer's loyalty program enters the pharmacy aisle. The display recognizes the loyalty ID (via app or card scan) and presents a personalized flu-shot reminder sponsored by a pharmaceutical brand. The same shopper later sees a connected television advertisement from the same campaign at home. Unified analytics combine the in-store exposure with the at-home impression, showing cross-channel incremental lift and ROAS for the campaign.

In another aspect, a shopper uses voice interaction with a display (“Show me reviews for these running shoes”). The display provides AR overlays of product details, and the advertiser's sponsored review content appears alongside organic information. Shopper dwell time, voice queries, and AR interactions are logged as tracked shopper actions and linked to subsequent purchases. This demonstrates how the system supports advanced engagement formats beyond static or video ads.

### II. Systems and Methods

In one aspect, the present disclosure provides a cloud-based system that operates on a distributed server architecture, and that is configured to handle advertising inventory including location and digital display management, campaign management, ad management, user and organization management, real-time auctions, bid management and ad serving, targeting and optimization, performance tracking via econometric attribution methods, action-based attribution methods, and other attribution techniques, reporting, and integrations with external platforms.

In one aspect, the present disclosure provides a system having a server configured to manage requests from mobile applications, to maintain associations between digital displays and product categories or location zone contexts, to perform data transformations, and to store advertisement inventory.

In one aspect, the present disclosure provides a system having a relational database configured to store information about advertisers, campaigns, bids, advertisement creatives, auction results, point-of-sale (POS) data, sales data, and performance metrics, and having APIs that facilitate communications between digital screens, mobile applications, and cloud-based servers.

In one aspect, the present disclosure provides a system having an ad delivery engine configured to select the most appropriate advertisement based on the results of an auction or allocation mechanism and to deliver the corresponding advertisement to the appropriate digital screen(s) based on predefined algorithms and optimization rules.

In one aspect, the present disclosure provides a system having mobile application(s) providing a user interface for displaying advertisements and digital content to shoppers, and that enables dynamic content updates to application users, based on real-time data from auctions, shopper interactions, or POS feeds.

In one aspect, the present disclosure provides a system including or leveraging: a cloud-based server or servers responsible for handling requests from client devices, for managing the bidding process, for storing advertisement inventory, for collecting performance data, and for performing data transformations; a communications network or networks; client devices/systems encompassing various devices enabling users to access and interact with the server system, and capable of running a shopper app or a retailer app; and digital high-definition displays placed within retail stores to show targeted advertisements and product related content that are mapped to one or more product categories or location zone contexts

In one aspect, systems and methods according to the present disclosure incorporate a brand control and pre-approval framework to ensure alignment with retailer requirements, brand safety standards, and competitive separation rules. Prior to any advertisement becoming eligible for display or auction participation, the creative assets, messaging, and targeting parameters are submitted to the retailer (or its designated agent) for review and approval. Only upon receiving explicit approval does the system make the advertisement eligible for bidding and display within the retail environment.

In one aspect, the system enforces competitive adjacency rules to prevent conflicting brands or product lines from being displayed in immediate succession or proximity within a defined time window and location. For example, advertisements for direct competitors such as Coca-Cola® and Pepsi® will not be scheduled back-to-back on the same screen or within a pre-determined competitive exclusion interval. These rules are configurable by the retailer at the category, brand, or product level and may be applied globally or at specific locations.

In one aspect, this brand control and approval framework operates in conjunction with the compliance and safety module, integrating both automated screening processes and human review workflows. This ensures that content not only meets legal, ethical, and safety requirements but also aligns with retailer merchandising strategies, brand positioning, and shopper experience guidelines.

### III. With Reference to the Figures

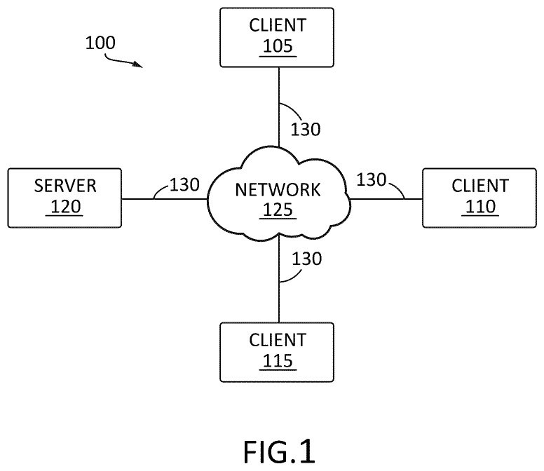

FIG. 1 is a simplified block diagram illustration of an example distributed computer network incorporating an example of a system for distributed advertisement management, performance tracking, and real-time bidding across multiple devices, user accounts, user data, sensor data, and the like, utilizing the described event processing techniques, according to the present disclosure. In particular, in one aspect, FIG. 1 highlights the performance tracking module and its role in producing tracked performance results used for optimizing future auction bids.

In another aspect, a central component of the distributed computer network 100 is a cloud-based server 120, responsible for handling requests from client devices, managing the bidding process, storing advertisement inventory, collecting performance data, and performing data transformations. The system thereby generates performance analytics and comprehensive, cross-channel performance metrics to populate integrated performance reports. Communication between the cloud-based server 120 and various client devices 105, 110, 115 is facilitated by the communication network 125. Communication protocols for this network may include transmission control protocol/internet protocol (TCP/IP), hypertext transfer protocol (HTTP), wireless application protocol (WAP), vendor-specific protocols, customized protocols, Internet telephony, internet protocol (IP) telephony, digital voice, voice of broadband (VoBB), voice over internet protocol (VOIP), public switched telephone (PSTN), local access network (LAN), wide area network (WAN), wireless networks, intranets, private networks, public networks, switched networks, and combinations thereof.

In another aspect, various client devices 105, 110, 115 includes within the scope of its meaning devices such as desktop computers, mobile communications devices, smartphones, tablets, laptops, and other computing devices that enable users to access and interact with the cloud-based server 120. A shopper app on the client devices 110 is a mobile application used by shoppers to receive and interact with digital advertisements in real-time. Retailer systems on the client devices 115 are used by retailers to manage their inventory, point-of-sale (POS) data, and other relevant operations. The cloud-based server 120 manages advertisement delivery, bid processing, advertisement inventory, performance tracking, and data storage. Digital screens 130 are high-definition displays placed within retail stores to show targeted advertisements and product related content.

In another aspect, the communication network 125 is merely illustrative of an example and does not limit the scope of the systems and methods as recited in the claims. One of ordinary skill in the art would recognize other variations, modifications, and alternatives. For example, more than one cloud-based server 120 may be connected to the communication network 125. Additional implementations of a distributed computer network 100 may further be illustrated in subsequent figures described herein.

In another aspect, the present disclosure addresses limitations in traditional in-store advertising methods, which involve analog advertisements or predefined digital content schedules, by introducing a programmatic approach to in-store advertising. This approach allows for targeted ad delivery in specific store aisle categories, such as “Organic Dog Treats,” and precise performance measurement in real-time.

In another aspect, the communication network 125 may be the Internet, while in other examples, it may be any suitable communication network, including LAN, WAN, wireless networks, intranets, private networks, public networks, switched networks, and combinations thereof. This flexibility ensures that the system can be adapted to various environments and requirements. For example, various advertising environments may include kiosk displays, endcap monitors, and mobile extensions tied to aisle-level product category touchpoints.

In another aspect, the distributed computer network 100 in FIG. 1 represents an example of the present disclosure, highlighting the components and their interactions for effective advertisement management, performance tracking, and real-time bidding in a brick-and-mortar retail environment.

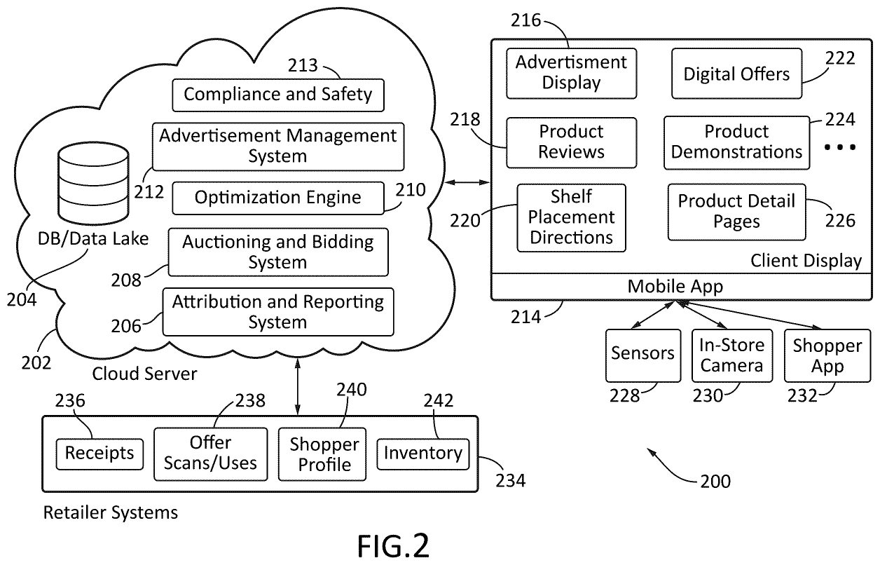

FIG. 2 is a system diagram illustration of example components and their interactions within the digital advertising system, including the cloud-based server, DB/data lake, advertising management system, optimization engine, auctioning and bidding system, attribution and reporting system, and various client devices, according to the present disclosure. In particular, in one aspect, a digital advertising system 200 configured for brick-and-mortar retail stores and various physical commercial locations. The system utilizes cloud-based software, mobile applications, and digital screens to deliver targeted advertisements programmatically and in real-time, leveraging an auction mechanism and performance tracking methods.

In another aspect, the digital advertising system 200 is not limited to displays positioned within retail store aisles, but extends to various physical commercial locations (e.g., brick-and-mortar retail stores). These locations can include aisle-level placements tied to specific product categories within retail store aisles (e.g., “Organic Snacks,” “Pain Relief,” “Pet Food”), broader in-store zones (e.g., deli, pharmacy waiting area, store entryway or exit), as well as digital billboards, kiosks, and other signage positioned outside or near retail stores. For example, a digital billboard located adjacent to a retail store may be targeted with advertisements for products that are confirmed in-stock at that store based on point-of-sale (POS) data ingested by the system. Likewise, in some examples, outdoor displays in broader geographic regions (e.g., city-level or regional billboards) may be selected dynamically based on POS data showing product distribution and availability within that region.

Accordingly, in another aspect, the phrase “various physical commercial locations” as used herein encompasses both indoor and outdoor contexts, including but not limited to aisle-level categories within retail store aisles, store-wide zones, perimeter and parking-lot displays, and proximate outdoor signage such as billboards or transit stops. Each of these locations may be programmatically targeted through the same digital advertising system 200, allowing advertisers to allocate spend across a unified platform that accounts for product availability, shopper context, and geographic targeting criteria.

In another aspect, the digital advertising system 200 further leverages this location granularity when conducting auctions and delivering advertisements. In particular, the system may determine the optimal advertisement not only based on bid amount and shopper engagement metrics, but also by correlating the location of the digital display to inventory availability and product categories. This ensures that advertisements are delivered in contexts where the promoted products are immediately purchasable, whether in-aisle, within the broader store environment, or in the case of nearby outdoor placements, at the associated retail store.

In another aspect, the cloud-based server 202 manages advertising campaigns, advertised products, campaign bids, targeting criteria, bid optimization, auction execution, advertisement inventory, ad delivery, performance tracking, and data storage. It operates on a distributed server architecture to ensure scalability and reliability, managing the core processing and coordination tasks. The cloud-based server 202 may be implemented using a plurality of interconnected computing devices, each equipped with one or more processors, memory units, and network interfaces, configured to operate in a distributed manner to provide redundancy and load balancing. The cloud-based server hosts the performance tracking module and the reporting pipeline that emits integrated performance reports. Targeting eligibility can be set at a product category level or a location zone context level to align delivery with store topology. Cloud-based server 202 also enables using the tracked performance results to modify future auction bids and win rates for the at least one product category or the location zone context.

In another aspect, advertisers can input bids based on various targeting criteria, including aisle category, geography, time of day, shopper ID, and other factors. This allows for highly targeted advertising that can reach the right audience at the right time and place. Once the bids are submitted, the cloud-based server 202 continuously monitors and optimizes them based on real-time advertising performance. Optimizations include future auction bids at a product category level or a location zone context level and may be tied to other contextual factors such as seasonal resets. For example, if advertisement A has a higher bid than advertisement B but has shown lower engagement and sales performance over the past few days, the system may automatically adjust by lowering the bid for advertisement A. This adjustment can increase the chances of advertisement B being displayed, allowing it to potentially outperform advertisement A. By dynamically managing bids in this way, the system ensures that ad placements are optimized not only for bid value but also for actual performance metrics, maximizing the effectiveness and return on investment of the advertising campaigns.

In another aspect, the auction mechanism may be configured to evaluate bids not only on bid amount, but also on multiple contextual factors including product availability, store location, shopper demographics, and proximity of the display to a product category or retail zone. For example, when two advertisers submit identical bids for ad space in a beverage aisle, the system may prioritize the advertiser whose product is confirmed in-stock at that store, thereby preventing wasted impressions. In another example, a winning bid for a billboard located adjacent to a pharmacy may be determined based not only on price but also on product relevance (e.g., health and wellness products) and regional POS data confirming product availability. By incorporating these multi-factor criteria into the winning bid determination, the system ensures both higher advertiser efficiency and a more relevant shopper experience.

In another aspect, within cloud-based server 202, data pool 204 stores vast amounts of raw data generated by the system, including advertised products, campaign data, campaign targeting and bids, auction execution including winners and losers, ad delivery execution, shopper ad interactions, ad performance metrics, and sales data. This data is processed and analyzed to optimize advertising strategies and improve targeting precision. The data pool 204 may utilize a combination of structured and unstructured data storage technologies to efficiently manage and retrieve large volumes of heterogeneous data.

In another aspect, the attribution and reporting system 206 (also referred to herein as the performance tracking module) tracks the performance of advertisements using two unique methods: an econometric-method and an action-based method. The time-based method calculates incremental sales attributed to specific ad display times by analyzing sales data from the retail store's point-of-sale (POS) system. This method may employ statistical algorithms to isolate the impact of advertisements from other factors affecting sales by comparing averages to historical averages, or utilizing causal studies that attempt to isolate the causal impact of advertisements. The action-based method tracks sales using tracked shopper actions such as scanning an offer on the screen, clicking on the screen itself to access product reviews or product detail pages, or other relevant actions, providing a direct correlation between ad exposure, engagement, and purchases.

In another aspect, the econometric method may utilize statistical models such as difference-in-differences analysis, time-series regression, or causal inference frameworks to isolate the incremental sales impact of advertisements. For example, the system may compare sales data for a SKU during time windows when the advertisement was displayed against baseline data from periods with no advertising, controlling for seasonality, promotions, and store traffic. The system may further identify “control stores” where the advertisement was not displayed, allowing for comparative analysis to more accurately quantify the causal effect of advertising. These econometric techniques provide advertisers with performance attribution similar in rigor to online advertising platforms, but applied to physical retail and out-of-home contexts.

In another aspect, the action-based attribution method may track direct shopper interactions with advertisements across both indoor and outdoor environments. For example, a shopper may scan a QR code displayed on a billboard near a retail store, which can be linked to subsequent purchases in that store's POS system. Similarly, in-aisle digital displays may present interactive elements such as offer codes, product review links, or purchase reminders via a connected shopper app. Each of these interactions creates a deterministic data point that links the advertisement to a shopper action (in one aspect, it directly links the advertisement to the shopper action), providing advertisers with high-confidence attribution of sales and engagement outcomes.

In another aspect, auctioning and bidding system 208 (also referred to herein as the auction module) allows advertisers to bid on ad display opportunities. Winning bids are selected based on factors such as bid amount, relevance to the target audience, store location, and in-stock inventory, ensuring that the most effective ads are shown to shoppers. The system employs a unique auctioning method that takes these various factors into account and is run on request whenever a digital screen is available for a new advertisement. Auction results are stored in data store for analysis and future optimization.

In another aspect, optimization engine 210 processes complex algorithms and rules that determine the selection and delivery of advertisements. It incorporates advanced artificial intelligence (AI) and machine learning (ML) techniques to enhance ad relevance and effectiveness, continually improving the system's performance through data-driven insights. The engine utilizes various AI methodologies, including but not limited to neural networks, decision trees, reinforcement learning, and Bayesian inference, to optimize ad selection and placement based on historical performance data and real-time shopper behavior. These optimizations are surfaced within performance analytics that guide pacing, bid deltas, and creative rotation by aisle and zone.

In another aspect, the optimization engine 210 employs probabilistic models to calculate and derive shopper propensities from data received from retailer systems 234. These propensities may include, but are not limited to: (1) propensity to purchase within a specific product category; (2) propensity to engage with a particular brand; (3) propensity to buy a specific product; (4) propensity to respond to certain types of promotional offers; (5) propensity to make impulse purchases, and (6) historical advertisement and promotion performance. The aforementioned propensities are calculated using machine learning algorithms that analyze historical purchase data, demographic information, and real-time behavioral cues. The system may utilize techniques such as logistic regression, random forests, or gradient boosting machines to generate these propensity scores.

In another aspect, the optimization engine 210 ingests batch or streaming incrementality estimates—such as sales lift per campaign, ad group, placement, or store produced by causal estimators. The engine computes an incrementality-adjusted value that may include one or more of: expected incremental revenue, uncertainty penalties, and contractual ROAS targets. The auction adapter transforms this value into a bid or ranking multiplier subject to budget and pacing constraints. Where lift is unavailable or statistically uncertain, the engine defaults to predictive proxies (e.g., expected engagement) with conservative exploration; as lift confidence improves, the policy shifts weight toward incrementality.

In another aspect, the optimization engine 210 may utilize ensemble methods that combine multiple AI models to generate more robust and accurate predictions. These ensemble methods may include, but are not limited to: (1) bagging; (2) boosting; (3) stacking; and (4) weighted averaging. The optimization engine 210 is further configured to adapt to changing market conditions and consumer preferences by employing online learning algorithms that update the models in real-time as new data becomes available. This ensures that the system remains responsive to emerging trends and shifts in consumer behavior.

Moreover, in another aspect, the optimization engine 210 incorporates a set of rules and constraints to ensure compliance with legal and ethical standards, including privacy regulations and advertising guidelines. These rules may be updated dynamically based on changes in applicable laws and regulations. The optimization engine also references tracked performance results and win rates to recommend optimizing future auction bids and enable dynamic adjustment of bids and ad content based on performance data at a product category level or at a location zone context level.

In another aspect, the combination of these advanced AI/ML techniques, probabilistic modeling, and experimental optimization enables the optimization engine 210 to deliver highly targeted and effective advertisements. By leveraging the wealth of data available from retailer systems 234 and other components of the digital advertising system 200, the optimization engine 210 can make real-time decisions that maximize the relevance and impact of each advertisement, thereby increasing the return on investment for advertisers and enhancing the shopping experience for consumers.

In another aspect, advertising management system 212 enables advertisers to create, manage, and monitor their ad campaigns. It provides a user-friendly interface for setting up ad parameters, viewing performance reports, and making adjustments based on real-time data. The interface delivers integrated performance reports, which include comprehensive, cross-channel performance metrics, combined conversion rates, and comparative return on ad spend (ROAS) across in-store and external platforms. The system may include features such as A/B testing capabilities, automated budget allocation, and predictive analytics to assist advertisers in optimizing their campaigns.

In another aspect, the digital advertising system 200 also includes a robust compliance and safety framework 213 that governs the content displayed on client display 214. The compliance and safety framework 213 integrates both automated moderation processes and human review mechanisms to ensure that advertisements adhere to both retailer and advertiser brand guidelines, as well as consumer safety standards. Automated algorithms screen content for inappropriate, offensive, or otherwise non-compliant material prior to display. In parallel, human moderators are available to review flagged content or special cases that require manual intervention. The compliance and safety framework 213 also ensures compliance with local advertising regulations, minimizing the risk of offensive or harmful content reaching shoppers. This layered approach protects both the brand integrity of retailers and advertisers while enhancing the in-store shopping experience for consumers.

In another aspect, client display 214 represents the digital screens within retail stores where advertisements are shown. These high-definition displays have network connectivity and are capable of rendering various ad formats, including static images, videos, and interactive content. The displays may incorporate touch-screen technology, gesture recognition, or voice control to enable shopper interaction. Each client display is mapped via planogram data, manual input or retailer-defined configurations to ensure in-store advertisements align with aisle-level product category touchpoints.

In another aspect, digital displays may include not only in-store flat-panel screens, but also digital endcap displays, checkout lane monitors, self-service kiosk screens, electronic shelf labels, and outdoor-facing signage such as parking lot displays and roadside billboards. These displays may support a variety of content formats, including interactive HTML5 applications, scannable QR codes, augmented reality overlays, or near-field communication (NFC) features for shopper engagement. Shopper-facing interfaces may present product reviews, enhanced product demonstrations, and in-aisle navigation directions. Displays may further be equipped with location-aware technologies (e.g., GPS, Bluetooth beacons) enabling precise association between advertisement exposure and shopper movements, whether inside the store, at its perimeter, or in adjacent outdoor environments.

In another aspect, client display 214 also includes several subcomponents to enhance shopper engagement and provide additional information:

In another aspect, in-store camera sensors 216 monitor shopper interactions and gather data on ad engagement and traffic. These sensors may employ computer vision algorithms to analyze shopper gaze, dwell time, and emotional responses to advertisements. These inputs feed real-time shopper behavior into performance analytics that populate integrated performance reports.

In another aspect, product reviews 218 are displayed on the client screens to provide additional information and influence shopper decisions. These reviews may be aggregated from multiple sources and filtered for relevance.

In another aspect, shelf placement directions 220 help shoppers locate products within the store, enhancing their shopping experience. These shelf placement directions can also provide navigation directions within a specific location, such as a precise bay or endcap, based on aisle maps and indoor positioning data. This feature may utilize indoor positioning technology and dynamic wayfinding algorithms to guide shoppers efficiently.

In another aspect, digital offers 222 are promotions and discounts displayed on the client screens, which shoppers can redeem at the point of sale. These offers may be personalized based on the shopper's profile and real-time behavior.

In another aspect, product demonstrations 224 showcase the features and benefits of products through video content or interactive displays. These demonstrations may adapt based on shopper interactions, providing more detailed information as needed.

In another aspect, product detail pages 226 provide comprehensive information about products, including specifications, prices, and availability. These pages may incorporate augmented reality (AR) features to allow shoppers to visualize products in different contexts.

In another aspect, sensors 228 are deployed throughout the store to collect data on shopper movements and interactions. This data is used to enhance ad targeting and measure performance, ensuring that ads are shown to the right audience at the right time. The sensors may include, but are not limited to, motion detectors, heat maps, and Bluetooth beacons for precise location tracking and shopper flow analysis.

In another aspect, in-store camera 230 captures footage of shopper behavior and interactions with advertisements, providing valuable insights for performance analysis and optimization of ad content. The camera system may utilize advanced image processing techniques to anonymize shoppers while still extracting meaningful behavioral data.

In another aspect, shopper app 232 is a mobile application used by shoppers to receive and interact with digital advertisements and offers. It enhances the personalized shopping experience and facilitates real-time updates to ad content, ensuring that shoppers receive the most relevant promotions based on their preferences and behavior. The app may incorporate features such as personalized shopping lists, loyalty program integration, and social sharing capabilities.

In another aspect, retailer systems 234 encompass the infrastructure used by retail stores to manage inventory, point-of-sale data, and other operations. These systems are integrated with the digital advertising system to ensure seamless ad delivery and performance tracking. Retailer systems 234 include several subcomponents:

In another aspect, receipts 236 are digital or printed records of purchases that include information about redeemed offers and ad-influenced purchases. These receipts may incorporate machine-readable codes to facilitate easy digital storage and analysis.

In another aspect, offer scans/uses 238 track the redemption of digital offers displayed in advertisements, providing direct attribution data. This component may employ various technologies such as barcode scanning, NFC, or optical character recognition to capture offer usage accurately.

In another aspect, shopper profile 240 contains data on individual shopper preferences, purchase history, and behavior, which is used to personalize advertisements. The profile may be continuously updated using machine learning algorithms to reflect changing shopper preferences and habits.

In another aspect, inventory 242 refers to the real-time stock levels of products in the store. This information is used by the auctioning and bidding system to ensure ads are relevant and timely. The inventory system may employ RFID technology or computer vision-based shelf monitoring to maintain accurate, up-to-the-minute stock levels. The server cross-references planogram data and retailer-defined configurations to ensure that associations remain correct. Such association is managed manually or automatically, or any combination thereof, and adjusted for other contextual factors such as temporary merchandising. The inventory system is cross-referenced with planogram data and retailer-defined configurations to verify that relevant advertisements are only delivered in contexts where the product is available, ensuring accurate attribution and preventing misaligned ads. Such association being managed manually or automatically, or any combination thereof, allows for dynamic updates in response to changes in layout or stock.

In another aspect, the integration of these components within the digital advertising system 200 provides a robust solution for delivering targeted advertisements in real-time, enhancing shopper engagement, and providing detailed performance metrics to advertisers. By leveraging cloud-based infrastructure, AI, and ML, the system optimizes ad delivery and ensures that advertisements remain relevant and effective, addressing the limitations of traditional in-store advertising methods.

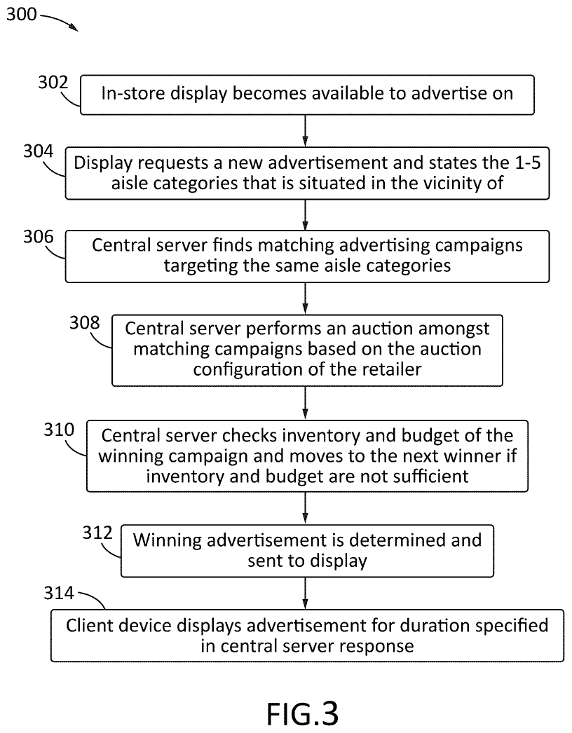

FIG. 3 is a flowchart of an example auction and advertisement display process, outlining the steps from an in-store display becoming available to the advertisement being shown, according to the present disclosure. In particular, in one aspect, FIG. 3 is a flowchart illustrating a method 300 for real-time advertisement selection and display in a retail environment. The process includes real-time auctions for each digital display containing available ad space, ensuring relevant advertisements are displayed at the product category level or location zone context level.

In another aspect, the method 300 comprises a series of steps that occur in sequence to facilitate the dynamic allocation and presentation of advertisements on in-store displays. The process is conducted via real-time auctions that rank relevant advertisements for the requesting screen and location zone context.

In another aspect, at step 302, an in-store display becomes available to advertise on. This availability may be triggered by various events, including but not limited to: the completion of a previously displayed advertisement, a predetermined time interval elapsing, or a detected change in shopper demographics or presence in the vicinity of the display. The display's availability is communicated to the central server through a network connection, which may utilize wireless protocols such as Wi-Fi or cellular data, or wired connections such as Ethernet. This event creates available ad space at the screen's location zone (with optional location zone context) for an impression request.

In another aspect, following the availability notification, at step 304, the display requests a new advertisement from the central server, specifying the one or multiple aisle categories it is situated in the vicinity. This request may include contextual information such as the display's location within the store, current time, recent shopper interaction data, and any other relevant parameters that could influence advertisement selection. The request is transmitted using a predefined data format that ensures efficient communication between the display and the central server.

In another aspect, upon receiving the request, the central server identifies matching advertising campaigns targeting the same aisle categories at step 306. This step involves filtering through available campaigns to find those that align with the specified aisle categories and are relevant to the display's location and shopper context.

In another aspect, at step 308, the central server initiates a mediation process to determine the optimal sales channel for the available impression, applying retailer-defined business logic to evaluate whether the opportunity should be fulfilled via a programmatic auction, a directly sold campaign, a sponsorship placement, or any other configured sales method. This mediation layer may consider factors such as contractual obligations, guaranteed delivery commitments, negotiated pricing, campaign pacing requirements, and yield optimization objectives. The mediation process also applies retailer-defined configurations (such as adjacency and brand-safety rules) and determines relevant advertisements based on at least one product category derived from planogram data, inventory data, manual input data, or merchandising data, or any combination thereof, before invoking the auction. The mediation layer also ensures determining relevant advertisements based on at least one product category derived from planogram data, inventory data, manual input data, or merchandising data, or any combination thereof, incorporating other contextual factors, as necessary.

In another aspect, if the mediation layer selects a programmatic pathway, the system proceeds to conduct an auction among the matching campaigns based on the retailer's configured auction type, such as a first-price or second-price model. The auction mechanism may employ artificial intelligence and machine learning techniques to evaluate all submitted bids and select the optimal advertisement for the given context. The auction module may apply incrementality-adjusted bid values provided by optimization engine 210, weighting bids by predicted incremental sales lift in addition to bid price.

In another aspect, if the mediation layer selects a directly sold or other non-auction-based pathway, the system retrieves the pre-approved advertisement associated with the applicable sales agreement and confirms compliance with any brand safety, competitive separation, and content approval rules.

In another aspect, once the winning or designated advertisement is identified through the mediation and selection process, the associated creative assets—whether image files, video content, or interactive elements—are packaged and transmitted to the requesting display over the network for rendering.

In another aspect, at step 308, the central server initiates a mediation process to determine the optimal sales channel for the available impression, applying retailer-defined business logic to evaluate whether the opportunity should be fulfilled via a programmatic auction, a directly sold campaign, a sponsorship placement, or any other configured sales method. This mediation layer may consider factors such as contractual obligations, guaranteed delivery commitments, negotiated pricing, campaign pacing requirements, and yield optimization objectives.

In another aspect, if the mediation layer selects a programmatic pathway, the system proceeds to conduct an auction among the matching campaigns based on the retailer's configured auction type, such as a first-price or second-price model. The auction mechanism may employ artificial intelligence and machine learning techniques to evaluate all submitted bids and select the optimal advertisement for the given context.

In another aspect, if the mediation layer selects a directly sold or other non-auction-based pathway, the system retrieves the pre-approved advertisement associated with the applicable sales agreement and confirms compliance with any brand safety, competitive separation, and content approval rules.

In another aspect, once the winning or designated advertisement is identified through the mediation and selection process, the associated creative assets—whether image files, video content, or interactive elements—are packaged and transmitted to the requesting display over the network for rendering.

In another aspect, following the mediation, at step 310, the central server checks the inventory and budget of the winning campaign. If the inventory or budget is insufficient, the system follows the defined business logic, ensuring that the selected advertisement can be fully supported and delivered. The system also records displayed advertisements with their associated location zone context and winning campaign identifiers to support downstream attribution and pacing. The system further records displayed advertisements tied to a*location zone context to build tracked performance results used in attribution and reporting.

In another aspect, finally, at step 312, the display receives the winning advertisement data and, at step 314, displays the advertisement for a specified duration. This duration may be predetermined or dynamically adjusted based on factors such as shopper engagement, time of day, or store traffic patterns. The display may also collect real-time data on shopper interactions and exposure with the advertisement, which can be communicated back to the central server for performance analysis and future optimization. Each impression outcome is logged for inclusion in tracked performance results.

In another aspect, the method 300 operates in a continuous loop, with step 310 flowing back into step 302 as the display becomes available for the next advertisement upon completion of the current one. This cyclical process ensures that the in-store displays consistently show the most relevant and valuable advertisements to shoppers, creating a liquid market for retailers and advertisers to more easily transact and maximizing both advertiser return on investment and the effectiveness of in-store marketing efforts.

In another aspect, a product catalog manager ingests planogram, POS, and merchandising feeds, automatically creates/updates product categories, and maps digital displays to categories and location zone contexts for auction eligibility.

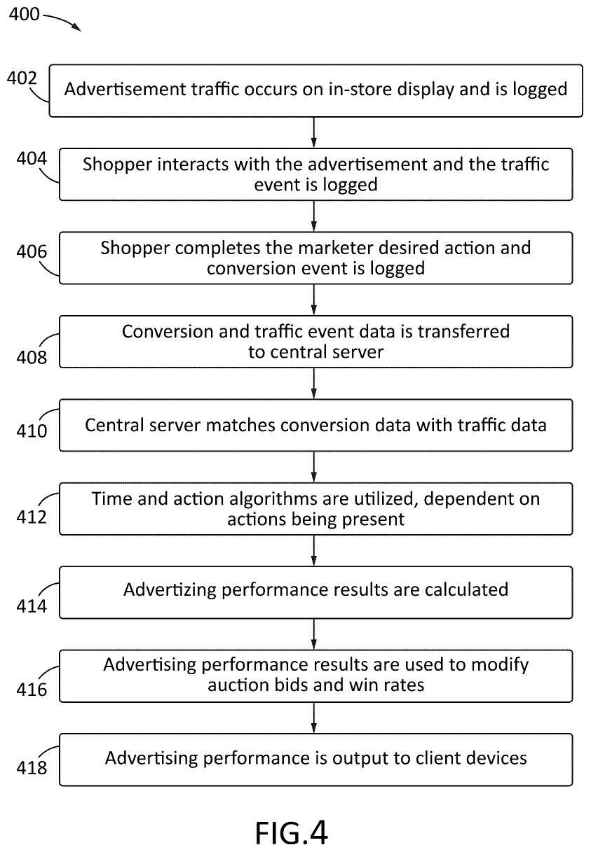

FIG. 4 is a flowchart of an example performance tracking and data flow process, detailing how advertisement traffic and conversion events are logged, processed, and used to calculate advertising performance, according to the present disclosure. In particular, in one aspect, FIG. 4 is a flowchart illustrating a method 400 for tracking, analyzing, and optimizing advertising performance in a retail environment, according to one example of the present disclosure. In another aspect, FIG. 4 shows how attributing sales resulting from these tracked actions to corresponding advertisements occurs within the performance tracking module.

In another aspect, the method 400 comprises a series of steps that occur in sequence to capture shopper interactions, measure advertising effectiveness, and refine future advertising strategies. This method is executed by the performance tracking module, which normalizes impression, action, and POS inputs into a common analytics schema for attribution and reporting.

In another aspect, at step 402, advertisement traffic occurs on an in-store display and is logged. This step involves the presentation of digital advertisements on the display and the systematic recording of various metadata associated with each ad impression. Such metadata may include, but is not limited to, the advertisement identifier, display time, duration, screen ID, format of advertisement, and contextual information about the store environment at the time of display. Advertisement traffic data is then logged and reported to advertisers in order to communicate what advertisements were effectively purchased and where they were displayed.

In another aspect, at step 404, shopper interaction with the advertisement, if available, is captured, and the resulting traffic event is logged. This may involve recording data such as viewer attention time, any touch or gesture interactions with interactive advertisements, and other measurable engagement metrics. Advertisement traffic engagement data is then logged and reported to advertisers in order to communicate what advertisements were effectively purchased and where they were displayed.

In another aspect, step 406 represents the completion of a marketer-desired action by the shopper, which is logged as a conversion event. This action may include purchasing the advertised product, requesting more information, installing an app, signing up for a newsletter, or any other predefined goal set by the advertiser. The conversion event is recorded with a timestamp and any relevant transaction details, establishing a potential link to the previously displayed advertisement. The system attributes sales resulting from these tracked actions to corresponding advertisements (for example, coupon redemption or QR deep-link engagement) and persists these outcomes as tracked performance results.

In another aspect, at step 408, the conversion and traffic event data are transferred to the central server. This data transmission occurs in real-time or at regular intervals, utilizing secure protocols to ensure data integrity and confidentiality during transfer.

In another aspect, Step 410 involves the central server matching conversion data with traffic data. This process employs econometric-based or action-based algorithms to correlate tracked shopper actions with the advertisements they were exposed to. The correlation is managed by attributing sales resulting from these tracked actions to corresponding advertisements using shopper-level identifiers such as loyalty program/rewards program IDs, along with metrics surrounding proportions of shoppers that participate in such actions on average in order to model and extrapolate the total amount of directly attributed purchases based on the number of shoppers that take an action that can be tied to a unique shopper-level identifier. This supports accurate deterministic measurement and informs incremental sales lifts. The resulting performance results are then used to modify future auction bids and win rates.

In another aspect, at step 412, the system utilizes an action-based algorithm to additionally directly link conversions to specific advertisements. For all conversion events, including those without explicit actions, an econometric-based algorithm is employed to infer relationships between ad exposures and subsequent conversions based on temporal proximity and other relevant factors. Therefore, the econometric-based algorithm estimates incremental conversions for all advertisements displayed at all times, while the action-based algorithm attributes conversions to traffic when offer codes, or other trackable IDs and codes such as shopper IDs detected from shopping apps, are present in both conversion and traffic data. Action-based attribution generates deterministic links by joining (a) ad display and impression logs containing unique auction/win identifiers with (b) tracked shopper actions (e.g., Ad-specific QR scan IDs, loyalty identifiers, coupon codes, etc.) and (c) POS receipts containing the same loyalty or coupon identifiers within a retailer-defined attribution window. Econometric attribution employs causal inference (difference-in-differences, synthetic controls, or propensity-score matching) executed at SKU/category/store levels, with ML covariate adjustment for promotions, price, inventory, seasonality, traffic, and daypart. The attribution system supports configurable crediting rules (last-touch, first-touch, view-through, and fractional multi-touch).

In another aspect, at step 414, advertising performance results are calculated using the matched data and selected algorithm. These calculations may include metrics such as attributed sales, units sold, conversion rates, return on ad spend (ROAS), advertising cost of sales (ACOS), customer acquisition cost, and other key performance indicators (KPIs) relevant to assessing advertising effectiveness. Additional metrics include incremental sales lifts and win rates, which capture causal uplift from displayed advertisements and auction outcomes. The platform applies performance analytics to recommend budget reallocations and optimizing future auction bids by aisle/category and location zone context.

In another aspect, step 416 involves using the calculated advertising performance results to modify auction bids and win rates for future ad placements. This may include automatic adjustments to bidding strategies, budget allocations, or targeting parameters to optimize campaign performance based on the insights gained from the performance analysis.

In another aspect, at step 418, the advertising performance results are output to client devices. This step ensures that advertisers, marketers, and other stakeholders have access to up-to-date performance metrics through user-friendly interfaces on their respective devices, enabling data-driven decision-making and strategy refinement. These results are delivered as integrated performance reports that generate comprehensive, cross-channel performance metrics that combine results from multiple advertising efforts. The reports summarize aisle-level product category touchpoints across various advertising environments, and include comparative return on ad spend (ROAS) and combined conversion rates. In some examples, the system also supports generating unified performance metrics that combine results from multiple advertising efforts for consolidated executive views.

In another aspect, the method 400 operates as a continuous feedback loop, with step 418 informing future iterations of the process beginning again at step 402. This iterative approach allows for constant refinement and optimization of advertising strategies based on real-world performance data, maximizing the effectiveness of in-store digital advertising campaigns over time.

FIG. 5 is a front perspective view of an illustration of an example shelf-mounted tablet and digital display located within an aisle of a physical commercial location, according to the present disclosure. In particular, in one aspect, the shelf-mounted tablet 500 can be deployed directly within a store aisle at the point of decision to maximize shopper engagement and attribution fidelity.

In another aspect, a shelf 502 supports a mounting bracket 504 that affixes a tablet casing 506 to the retail fixture. The tablet casing 506 encloses the shelf-mounted tablet 500 with a screen area 508 that renders a video advertisement 510 including a QR code 512. Shopper interactions 514 such as touch, scan, gaze detection, scrolling, or voice queries are logged as tracked shopper actions. These shopper interactions 514 (also referred to herein as tracked shopper actions) are joined with impression identifiers from the auction module and point-of-sale receipts containing loyalty identifiers or coupon codes to form deterministic attribution datapoints. The performance tracking module uses these datapoints to generate holistic performance reports and to modify future auction bids at the product category or location zone context level.

In another aspect, shelf 502 represents a physical retail shelf or fixture surface that supports products available for purchase. The shelf provides a structural foundation for mounting digital hardware in direct association with the corresponding product category. By affixing the display hardware directly to the shelf 502, the system ensures that the advertisement content rendered on the display is contextually tied to the products available in that physical commercial location, thereby strengthening aisle-level targeting precision.

In another aspect, the mounting bracket 504 is secured to the shelf 502 and serves as the intermediary fixture component that attaches the tablet casing 506 to the retail infrastructure. The mounting bracket 504 may include clamping mechanisms, screw fastenings, or other securement techniques designed for durability in high-traffic retail environments. The bracket further positions the display at an optimal viewing angle for shoppers walking down the aisle, enhancing visibility and engagement with displayed advertisements. The system contemplates that mounting bracket 504 may be adapted to various retail fixtures, including pegboards, gondolas, or endcaps, allowing flexible deployment across store formats.

In another aspect, the tablet casing 506 is coupled to mounting bracket 504 and encloses the shelf-mounted tablet or equivalent computing device. The tablet casing 506 may provide protective housing to prevent tampering, environmental damage, or theft. In some examples, the tablet casing 506 also incorporates integrated cable routing and power management, ensuring that the shelf-mounted tablet 500 remains powered while maintaining a clean and professional aesthetic. The casing therefore not only secures the hardware but also supports continuous operation of the system within a retail setting.

In another aspect, screen area 508 represents the visible digital display region of the shelf-mounted tablet 500 enclosed within the tablet casing 506. Screen area 508 renders rich media advertisements, including static images, videos, animations, and interactive interfaces. The rendering may be dynamically updated through the cloud-based server and auction module to reflect winning bids relevant to the aisle category or location zone context associated with shelf 502. This ensures that the advertisements displayed on screen area 508 are timely, relevant, and optimized for the surrounding shopper environment.

In another aspect, video advertisement 510 is content rendered on screen area 508. In some examples, video advertisement 510 may include product demonstrations, brand messaging, or promotional offers specifically targeted to the product category associated with shelf 502. Video advertisement 510 is dynamically selected by the auction module and may be adjusted in real time to optimize performance based on tracked engagement and sales outcomes. Because video advertisement 510 is displayed at the shelf where purchase decisions occur, it provides a high-intent advertising opportunity analogous to online sponsored product placements.

In another aspect, QR code 512 is displayed as part of video advertisement 510 and provides a scannable, machine-readable element for shopper interaction. QR code 512 may encode product detail pages, promotional coupons, loyalty program enrollment links, or other calls to action. By scanning QR code 512 with a smartphone, shoppers generate deterministic identifiers that can be tied directly to the advertisement displayed on screen area 508. QR code 512 therefore creates an action-based attribution signal that links shopper engagement to downstream purchases captured in POS receipts.

In another aspect, shopper interactions 514 encompass a variety of engagement modalities with screen area 508 and video advertisement 510. Shopper interactions 514 may include touch inputs (e.g., tapping interactive content), scanning QR code 512, dwell time measured through gaze detection, scrolling through product information, or issuing voice queries where voice-enabled interfaces are supported. These interactions are logged in real time as tracked shopper actions, providing granular engagement data that informs attribution modeling and campaign optimization.

In another aspect, shopper interactions 514 are joined with impression identifiers from the auction module and with point-of-sale receipts containing loyalty identifiers or coupon codes to form deterministic attribution datapoints. For example, if a shopper scans QR code 512 and subsequently redeems a coupon associated with that scan at checkout, the system creates a one-to-one link between the displayed advertisement and the purchase outcome. This linkage produces a deterministic attribution record, which is stored within the attribution system for reporting and analysis.

In another aspect, the performance tracking module utilizes these deterministic attribution datapoints to generate holistic performance reports. These reports may include metrics such as attributed units sold, cost-per-purchase, return on ad spend (ROAS), advertising cost of sales (ACOS), and incremental sales lift. The performance tracking module also leverages these datapoints to refine future auction strategies by adjusting bid values at the product category or location zone context level. For example, if video advertisement 510 is observed to drive higher-than-expected incremental sales lift in the organic dog treats aisle, the optimization engine may recommend increasing bids for that product category in subsequent auctions.

Accordingly, in another aspect, FIG. 5 illustrates how a shelf-mounted tablet 500 integrates physical hardware components (shelf 502, mounting bracket 504, tablet casing 506, screen area 508), digital advertisement content (video advertisement 510, QR code 512), shopper engagement mechanisms (shopper interactions 514), and attribution linkages into a cohesive system that supports both deterministic and econometric measurement of in-store advertising effectiveness.

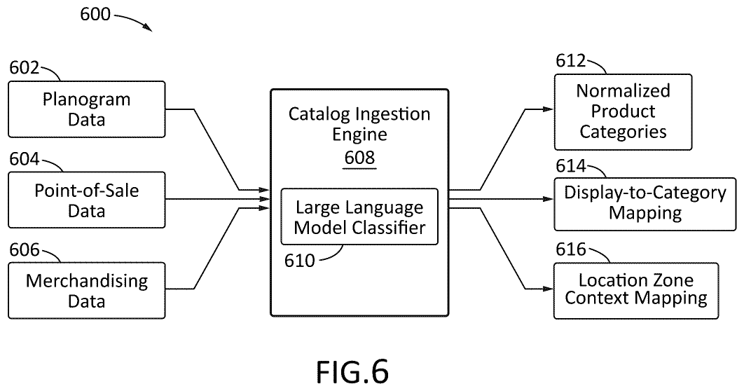

FIG. 6 is a system diagram illustration of an example product catalog ingestion and management system, according to the present disclosure. In particular, in one aspect, FIG. 6 illustrates a product catalog ingestion and management system 600 illustrating how disparate retail data sources are normalized and mapped to support precise aisle-level targeting and dynamic auctioning.

In another aspect, inputs include planogram data 602, point-of-sale (POS) data 604, and merchandising data 606. These inputs are ingested into a catalog ingestion engine 608 that incorporates a large language model (LLM) classifier 610 to normalize SKUs and attributes. The engine produces normalized product categories 612, a display-to-category mapping 614, and a location zone context mapping 616. This automation enables advertisers to target hundreds or thousands of categories simultaneously, ensuring that the auction module dynamically selects relevant advertisements aligned with product category and location zone context.

In another aspect, planogram data 602 represents retailer-defined information about shelf layouts, bay structures, and product positioning within the store. Planogram data 602 provides the spatial relationship between digital displays and adjacent product categories, ensuring that advertisements delivered to a display are contextually aligned with the items physically available nearby. By incorporating planogram data 602, the system maintains accurate associations between product categories and display locations even as store layouts change due to seasonal resets or merchandising updates.

In another aspect, point-of-sale (POS) data 604 supplies transaction-level detail, including SKU identifiers, quantities sold, prices, and timestamps of purchase. POS data 604 provides ground-truth sales outcomes that enable validation of attribution models. By linking advertisement exposures to purchases reflected in POS data 604, the system can calculate incremental lift, cost-per-purchase, and return on ad spend (ROAS). Integrating POS data 604 into catalog ingestion ensures that product eligibility rules reflect real-time availability and that ads are only served when products are in stock at the associated store.

In another aspect, merchandising data 606 refers to retailer or supplier-provided information on product groupings, promotional schedules, and hierarchical categorization of items. Merchandising data 606 allows the system to align advertisements with higher-order categories (e.g., “organic snacks” or “pet wellness”) as well as granular subcategories (e.g., “organic dog treats” or “antacid tablets”). This hierarchical layering enables advertisers to bid flexibly across broad or narrow scopes, depending on campaign objectives, while ensuring alignment with retailer merchandising strategies.

In another aspect, catalog ingestion engine 608 receives planogram data 602, POS data 604, and merchandising data 606 as inputs. Catalog ingestion engine 608 performs extraction, transformation, and loading (ETL) functions to harmonize disparate schemas into a unified catalog format. In some examples, catalog ingestion engine 608 may also resolve conflicts between data sources (e.g., reconciling POS identifiers with merchandising hierarchies) and ensure that updates to store layout or product inventory are reflected in real time within the advertising system. Catalog ingestion engine 608 therefore acts as the central orchestration layer for transforming raw retail inputs into actionable targeting data.

In another aspect, large language model (LLM) classifier 610 is embedded within catalog ingestion engine 608 and performs semantic normalization of SKUs and attributes. LLM classifier 610 analyzes product titles, descriptions, and metadata to standardize naming conventions, eliminate duplicates, and infer missing attributes such as flavor, size, or brand family. For example, SKUs labeled as “dog biscuits—organic chicken flavor” and “organic chicken dog treats” may be recognized by LLM classifier 610 as belonging to the same normalized category. This automated normalization reduces manual data cleaning efforts and enables advertisers to target large assortments with consistent precision.

In another aspect, normalized product categories 612 are outputs generated by catalog ingestion engine 608 and LLM classifier 610. These categories provide a structured taxonomy of products that advertisers can directly target within the auction module. By consolidating raw SKUs into normalized product categories 612, the system ensures scalable campaign management where advertisers can reach hundreds or thousands of categories simultaneously without individually mapping every SKU.

In another aspect, Display-to-category mapping 614 is another output of catalog ingestion engine 608. Display-to-category mapping 614 links each registered digital display to one or more normalized product categories based on planogram data 602 and merchandising data 606. For example, a shelf-mounted tablet in the “organic dog treats” section of the pet aisle may be mapped specifically to that category. Display-to-category mapping 614 enables the auction module to select advertisements most relevant to the display's physical context, thereby maximizing ad relevance and purchase intent alignment.

In another aspect, Location zone context mapping 616 further enriches targeting by associating displays with broader store zones or contextual groupings. Location zone context mapping 616 may include associations such as “pharmacy waiting area,” “checkout lane,” or “seasonal endcap.” By layering location zone context on top of product categories, location zone context mapping 616 allows advertisers to refine campaign strategies to shopper journeys and store traffic flows. For example, a cold-medicine brand may target both the “cough & cold” product category and the “pharmacy waiting area” zone to maximize shopper exposure before purchase.

In another aspect, normalized product categories 612, display-to-category mapping 614, and location zone context mapping 616 outputs enable advertisers to run highly granular yet scalable campaigns. The normalized categories, display mappings, and zone contexts are transmitted to the auction module, which dynamically selects winning advertisements aligned with both product category and location zone context. This process ensures that advertisements are not only relevant to the products on the shelf but also contextually optimized to shopper environment and behavior.

Accordingly, in another aspect, FIG. 6 illustrates how product catalog ingestion and management system 600 transforms disparate retail data streams into a unified, normalized structure that powers dynamic targeting, efficient auction execution, and high-precision in-store advertising. By leveraging planogram data 602, POS data 604, and merchandising data 606, and automating normalization via catalog ingestion engine 608 and LLM classifier 610, the system ensures accurate, scalable, and contextually aligned ad delivery.

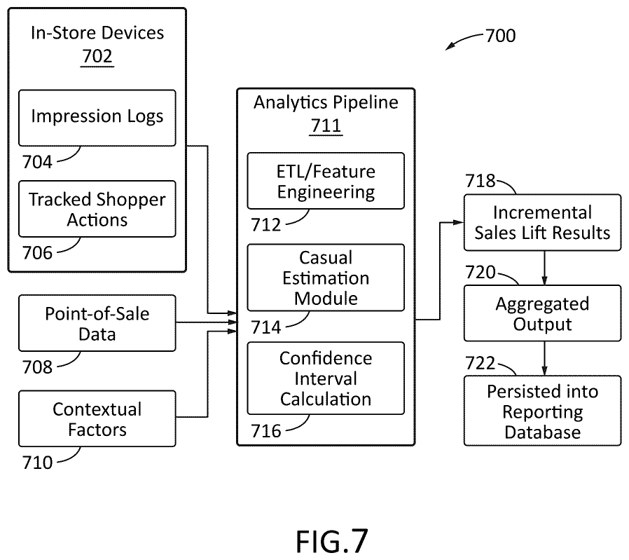

FIG. 7 is a flowchart of an example econometric sales lift process, according to the present disclosure. In particular, in one aspect, FIG. 7 illustrates how a system according to the present disclosure uses causal inference methods to measure incremental sales attributable to in-store advertising, combining device-level impression data with point-of-sale (POS) outcomes and contextual factors.

In another aspect, In-store devices 702 represent the physical digital displays, sensors, and connected endpoints deployed throughout the retail environment. These devices generate logs of advertisement impressions and shopper interactions, providing the raw inputs necessary for attribution and econometric analysis. In some examples, in-store devices 702 may include shelf-mounted tablets, endcap monitors, or interactive kiosks, each configured to record timestamped delivery of specific ad creatives.

In another aspect, Impression logs 704 are outputs generated by in-store devices 702. Each impression log includes metadata such as advertisement identifier, screen identifier, campaign identifier, store location, timestamp, display duration, and winning bid identifiers from the auction module. These logs provide the foundational exposure data required to link advertisements to subsequent sales and enable direct correlation between auction outcomes, engagement, and sales lift.

In another aspect, tracked shopper actions 706 represent engagement events initiated by shoppers in response to displayed advertisements. Examples include QR code scans, coupon redemptions, voice queries, touchscreen inputs, or dwell-time observations via gaze detection. Each action is timestamped and, when available, associated with a shopper identifier (e.g., loyalty ID). These datapoints bridge ad exposures to downstream POS sales and allow for deterministic attribution of purchases.

In another aspect, POS sales data 708 supplies transaction-level records from retailer checkout systems. Each record may include SKU identifiers, basket contents, loyalty IDs, purchase timestamps, and store identifiers. POS data provides the “ground truth” of purchases against which advertisement effectiveness is measured. When combined with impression logs 704 and tracked shopper actions 706, POS sales data 708 enables both deterministic and econometric attribution of ad-driven sales.

In another aspect, Contextual factors 710 represent covariates that influence shopper behavior and sales outcomes, including time of day, day of week, store location, seasonal promotions, and price changes. These variables are critical to isolating the causal effect of advertising by controlling for confounding influences. For instance, a sales lift observed during a holiday promotion must be distinguished from lift attributable to an advertisement; contextual factors 710 provide the adjustment inputs for this inference.

In another aspect, Analytics pipeline 711 ingests impression logs 704, tracked shopper actions 706, POS sales data 708, and contextual factors 710. The pipeline performs extraction, transformation, and feature engineering, preparing the data for econometric modeling. Operations may include normalizing time windows, aligning shopper identifiers, encoding categorical features, and generating synthetic control groups for causal comparison. This ensures the inputs are harmonized and structured for accurate econometric estimation.

In another aspect, ETL and feature engineering module 712 is a subcomponent of the analytics pipeline 711. It executes data cleansing, schema normalization, and construction of derived features such as lagged sales, price elasticity variables, or shopper visit frequency. By preparing features that capture both historical and contemporaneous influences, ETL and feature engineering module 712 enables robust econometric modeling that isolates the incremental effect of advertising exposures.

In another aspect, Causal estimation module 714 applies econometric techniques such as difference-in-differences, synthetic controls, or propensity-score matching to estimate incremental sales attributable to advertisement exposures. It compares outcomes between exposed and unexposed groups while controlling for contextual factors 710, and quantifies causal lift. For example, if shoppers exposed to a detergent advertisement purchase 20% more units than a statistically matched unexposed group, causal estimation module 714 attributes that difference to the advertisement.

In another aspect, Confidence interval calculation module 716 evaluates the statistical precision of estimated sales lift by computing standard errors and confidence intervals. This ensures that reported incremental lift metrics reflect not only point estimates but also uncertainty ranges, giving advertisers transparency into the reliability of results and reducing the risk of over- or under-interpreting effectiveness.

In another aspect, Incremental sales lift results 718 are outputs of the econometric modeling process. These results quantify incremental units sold, incremental revenue generated, and associated confidence intervals. They provide a probabilistic attribution measure that complements deterministic datapoints derived from tracked shopper actions 706.

In another aspect, Aggregated outputs 720 roll up incremental sales lift results 718 by campaign, ad group, product category, or location zone context. These aggregations allow advertisers to view performance across multiple levels of granularity—from aisle-level campaigns to chain-wide rollouts—and make insights actionable for both tactical optimization and strategic budget allocation.

In another aspect, Reporting database 722 stores aggregated outputs 720 for use in holistic performance reports and optimization engines. The database may be implemented as a distributed data warehouse with real-time query access and dashboard integration. Persisting econometric results allows advertisers to continuously monitor incremental lift across campaigns and compare econometric outputs with deterministic attribution datapoints.

In another aspect, the econometric results stored in reporting database 722 are combined with deterministic attribution datapoints (e.g., QR scans, coupon redemptions, or loyalty ID matches) to generate holistic performance reports. By integrating probabilistic econometric insights with deterministic one-to-one datapoints, the system provides a comprehensive picture of campaign effectiveness. These reports directly inform optimization of future auction bids, enabling prioritization of ad placements that demonstrate both high engagement and statistically validated incremental sales lift.

Accordingly, in another aspect, FIG. 7 illustrates how econometric sales lift process 700 integrates device-level exposures, shopper interactions, POS outcomes, and contextual covariates into a structured analytics pipeline 711. Through ETL and feature engineering module 712, causal estimation module 714, and confidence interval calculation module 716, the system delivers statistically rigorous incremental sales lift results 718, aggregates them into aggregated outputs 720, and persists them in reporting database 722. This end-to-end process provides advertisers with causal insights that not only validate performance but also drive optimization of future auction and campaign strategies.

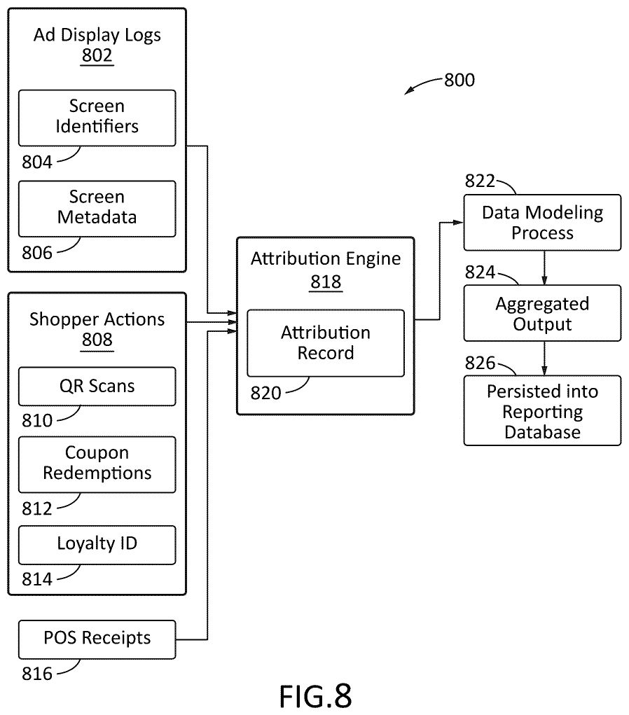

FIG. 8 is a flowchart of an example deterministic attribution linkage process, according to the present disclosure. In particular, in one aspect, a deterministic attribution linkage process 800 shows how individual shopper actions and purchases are linked (directly or indirectly) to specific advertisement exposures using common identifiers, producing one-to-one attribution records that complement econometric methods.

In another aspect, Ad display impression logs 802 represent system-generated records of advertisements shown on in-store digital displays. Each log entry may include metadata such as campaign identifier, creative identifier, screen identifier, store location, timestamp, and auction outcome. Ad display impression logs 802 provide the foundational exposure dataset for deterministic attribution, ensuring that every instance of an advertisement impression is uniquely identifiable.

In another aspect, Screen identifiers 804 are included within ad display impression logs 802 and specify the exact digital display device that rendered a given advertisement. Each screen identifier of the screen identifiers 804 is mapped to one or more product categories or location zone contexts via the catalog ingestion and planogram mapping described in earlier figures. By embedding screen identifiers 804 within display logs, the system ensures that exposure events can be tied back to the specific aisle or zone in which they occurred, supporting both contextual targeting and attribution.

In another aspect, Metadata 806 comprises supplemental details associated with each impression, including auction-winning bid identifiers, advertisement duration, and engagement opportunities available on screen (e.g., presence of a QR code). Metadata 806 enhances attribution by linking exposures to campaign-level strategies and creative variants, thereby allowing advertisers to compare performance across different bidding strategies, creatives, or contextual factors.

In another aspect, Shopper action events 808 represent engagement behaviors taken by shoppers in response to ad exposures. These may include scanning a QR code displayed on screen, redeeming a coupon, tapping an interactive element, or entering a loyalty ID into a connected app. Shopper action events 808 provide deterministic signals that link shopper behavior directly to advertisement exposures, bridging the gap between ad display impression logs 802 and downstream purchases.

In another aspect, QR scans 810 are one form of shopper action event. When a shopper scans a QR code displayed in an advertisement, the scan is recorded as a unique event tied to both the advertisement and the scanning device or app. QR scans 810 may redirect shoppers to digital product detail pages, retailer apps, or promotional offers, while simultaneously generating unique identifiers used to link the scan event to subsequent purchases.

In another aspect, Coupon redemptions 812 represent another form of shopper action event. A shopper may scan or otherwise acquire a digital coupon from an advertisement and later redeem it during checkout. Coupon redemptions 812 create a deterministic linkage between the advertisement exposure and the purchase outcome, as the coupon identifier ties the redemption back to the specific campaign and creative that offered it.

In another aspect, Loyalty ID inputs 814 are another key form of shopper action. Shoppers may provide loyalty IDs through retailer apps, checkout terminals, or linked devices when engaging with advertisements. These loyalty identifiers create a persistent shopper-level key that connects exposures, actions, and purchases into a unified record. Loyalty ID inputs 814 therefore enable reliable deterministic attribution while maintaining anonymization as required by retailer privacy policies.

In another aspect, POS receipts 816 contain itemized records of actual purchases, including SKUs, prices, timestamps, store identifiers, and loyalty IDs when available. POS receipts 816 are ingested into the attribution system and matched with shopper action events 808 and ad display impression logs 802 to validate that purchases occurred within a defined attribution window following exposure to an advertisement.

In another aspect, Attribution engine 818 is the central processing component that ingests ad display impression logs 802, shopper action events 808, and POS receipts 816. Attribution engine 818 employs common identifiers—such as loyalty IDs, coupon codes, or QR scan IDs—to link advertisement exposures to subsequent shopper actions and purchases. By joining these datasets, attribution engine 818 produces attribution records that represent one-to-one deterministic connections between ad exposures and purchase outcomes.

In another aspect, Attribution records 820 are the structured outputs of attribution engine 818. Each record may include fields such as advertisement identifier, shopper identifier, SKU purchased, timestamp, and attribution rule applied (e.g., last-touch or first-touch). Attribution records 820 provide advertisers with high-confidence evidence of the causal pathway from ad exposure to sale, mirroring deterministic attribution frameworks commonly used in online advertising.

In another aspect, Data modeling process 822 processes attribution records 820 to adjust for behavioral discrepancies among shoppers. For example, some shoppers may consistently redeem coupons, while others may rarely do so even when influenced by advertising. Data modeling process 822 applies statistical normalization to estimate the total sales attributable to advertisements beyond the directly observed deterministic actions. This step ensures that attribution does not undercount influence due to heterogeneous shopper behaviors.

In another aspect, Aggregated outputs 824 are rollups of attribution results by campaign, ad group, product category, or location zone context. These outputs allow advertisers to view deterministic attribution performance at multiple levels of analysis, facilitating both granular campaign adjustments and high-level budget decisions.

In another aspect, Reporting database 826 stores aggregated outputs 824 along with the underlying attribution records 820 for use in advertiser dashboards and performance analytics. Reporting database 826 enables real-time access to deterministic attribution results, supporting integration into unified analytics alongside econometric lift measures.

In another aspect, the econometric results described in FIG. 7, for example, are aggregated and combined with deterministic attribution datapoints generated by FIG. 8. By synthesizing both probabilistic and deterministic evidence, the system produces holistic performance reports that provide advertisers with a complete view of advertising effectiveness. These reports also inform optimization of future auction bids by highlighting campaigns, categories, or store zones that drive measurable outcomes.

Accordingly, in another aspect, FIG. 8 illustrates how deterministic attribution linkage process 800 ties together ad exposures, shopper actions, and purchases into structured attribution records 820, processes them through data modeling process 822, and persists results into reporting database 826, thereby enabling precise, one-to-one attribution in physical retail environments.

Accordingly, in another aspect, ad display impression logs 802 contain screen identifiers 804 and corresponding metadata 806. Shopper action events 808 include QR scans 810, coupon redemptions 812, and loyalty ID inputs 814. POS receipts 816 capture actual purchases with timestamps, SKUs and loyalty IDs. These elements are input to the attribution engine 818 and use common identifiers, such as loyalty IDs to create a link between ads displayed, a unique shopper action, and a shopper purchase, to form an attribution record of the attribution records 820, establishing a deterministic, one-to-one connection between an advertisement exposure and a purchase outcome. The attribution records 820 are stored and processed through a data modeling process 822 to compensate for behavioral discrepancies between shoppers and estimate the total attributed sales that are then aggregated into aggregated outputs 824 (by campaign, ad group, product category, or location zone context) and persisted into a reporting database 826. The econometric results are aggregated and combined with deterministic attribution datapoints to generate holistic performance reports and to inform optimization of future auction bids.

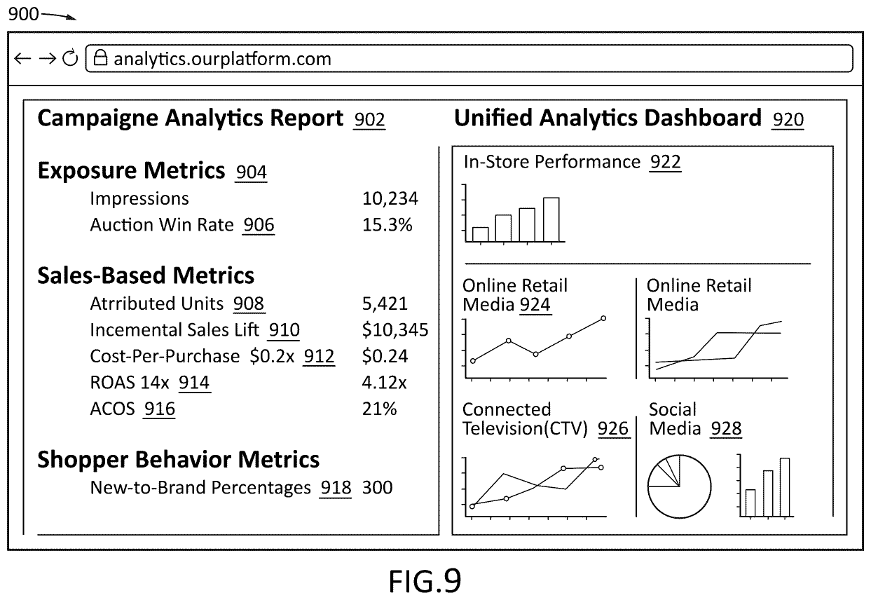

FIG. 9 is a digital illustration of an example campaign analytics outputs report, according to the present disclosure. In particular, in one aspect, FIG. 9 shows campaign analytics outputs 900 demonstrating how a system according to the present disclosure translates raw attribution data into advertiser-facing reports that unify exposure, sales, and shopper engagement metrics across multiple channels.

In another aspect, A campaign analytics report 902 lists exposure metrics such as impressions 904 and auction win rate 906, sales-based metrics such as attributed units 908, incremental sales lift 910, cost-per-purchase 912, return on ad spend (ROAS) 914, and advertising cost of sales (ACOS) 916, and shopper behavior metrics such as new-to-brand percentages 918. A unified analytics dashboard 920 displays comparative panels including an in-store performance panel 922, an online retail media panel 924, a connected television (CTV) panel 926, and a social media panel 928. These unified analytics dashboards generate integrated performance reports that merge econometric attribution with action-based attribution to produce holistic performance reports with cross-channel performance metrics.

In another aspect, Campaign analytics report 902 represents a structured reporting document or dashboard panel that organizes performance results for a given advertising campaign. Campaign analytics report 902 consolidates both deterministic and econometric attribution results, presenting them in an accessible form for advertisers and retailers. The report is generated by the reporting database and populated in near real time.

In another aspect, Impressions 904 are an exposure metric within campaign analytics report 902. Impressions 904 quantify the number of times an advertisement was displayed on in-store screens. Each impression record is tied to an impression identifier from ad display logs, enabling precise counts of ad exposures by campaign, screen, or location zone context. This metric mirrors online impression reporting but applies it to the in-store environment.

In another aspect, Auction win rate 906 is another exposure metric. Auction win rate 906 measures the percentage of times a campaign's bids won available impression opportunities relative to total auctions entered. Auction win rate 906 provides advertisers with insight into competitiveness of their bidding strategies, indicating whether higher bids or refined targeting criteria may be necessary to increase share of voice within a category or location.

In another aspect, Attributed units 908 are a sales-based metric in campaign analytics report 902. Attributed units 908 represent the number of individual product units purchased that can be directly or probabilistically tied to advertisement exposures. Attributed units 908 are derived from both deterministic linkage (e.g., coupon redemption or loyalty ID match) and econometric modeling (incremental sales relative to baseline).

In another aspect, Incremental sales lift 910 quantifies the causal increase in product sales attributable to advertising exposures. Incremental sales lift 910 is calculated by comparing exposed versus unexposed groups, as described in FIG. 7, and reported here as an absolute number of additional units sold or as a percentage increase over baseline. Incremental sales lift 910 provides a probabilistic measure of campaign effectiveness.

In another aspect, Cost-per-purchase 912 is a derived efficiency metric. Cost-per-purchase 912 divides campaign spend by attributed units 908, yielding an advertiser-facing indicator of how efficiently advertising dollars translate into purchases. This metric enables advertisers to compare campaign effectiveness across products, categories, and channels.

In another aspect, return on ad spend (ROAS) 914 is another efficiency metric. ROAS 914 represents the ratio of attributed revenue to advertising spend. ROAS 914 allows advertisers to benchmark campaigns against financial objectives and optimize budget allocation to the highest-yielding initiatives.

In another aspect, Advertising cost of sales (ACOS) 916 is reported alongside ROAS 914 as a reciprocal measure. ACOS 916 expresses advertising spend as a percentage of attributed revenue, providing an additional lens on efficiency. Advertisers may use ACOS 916 thresholds to guide bidding strategies, ensuring that spend remains aligned with profitability objectives.

In another aspect, New-to-brand percentages 918 represent a shopper behavior metric. This measure calculates the proportion of attributed purchases made by shoppers who had not previously purchased the advertised brand within a defined lookback window. New-to-brand percentages 918 help advertisers assess whether campaigns are driving incremental category penetration versus repeat purchases.

In another aspect, Unified analytics dashboard 920 integrates these metrics into a consolidated visualization. Unified analytics dashboard 920 provides advertisers with interactive panels, filters, and comparative displays, enabling cross-campaign and cross-channel analysis. It consolidates in-store and external channel data into a single reporting interface.

In another aspect, In-store performance panel 922 is one subcomponent of unified analytics dashboard 920. In-store performance panel 922 displays in-store specific results such as impressions, auction win rate, and attributed units by aisle or store. This panel contextualizes campaign performance within physical retail environments.

In another aspect, Online retail media panel 924 provides performance results from online retail platforms. Online retail media panel 924 enables advertisers to compare in-store and online effectiveness side by side, bridging the gap between physical and digital retail media.

In another aspect, connected television (CTV) panel 926 integrates performance data from streaming television campaigns. Panel 926 allows advertisers to evaluate how CTV impressions and conversions complement in-store campaign results.

In another aspect, social media panel 928 incorporates performance data from platforms such as Meta™, TikTok™, or other social channels. Social media panel 928 provides advertisers with a unified cross-channel view, allowing campaigns to be evaluated consistently across disparate environments.

In another aspect, Together, in-store performance panel 922, online retail media panel 924, connected television (CTV) panel 926, and social media panel 928 generate integrated performance reports that merge econometric attribution with action-based attribution across all relevant channels. By combining results from multiple advertising environments, the system produces holistic performance reports with cross-channel performance metrics. FIG. 9 therefore, in another aspect, illustrates how raw attribution data is translated into actionable, cross-channel insights delivered through campaign analytics report 902 and unified analytics dashboard 920.

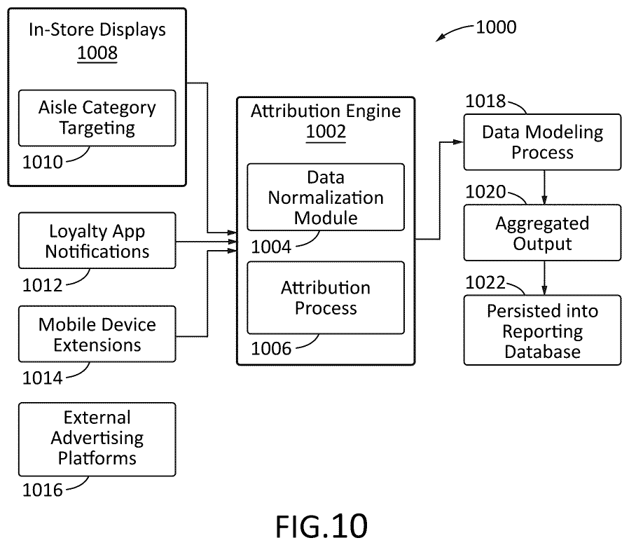

FIG. 10 is a system and process diagram illustration of an example multi-channel advertising strategy or method, according to the present disclosure. In particular, in one aspect, FIG. 10 illustrates a multi-channel advertising strategy 1000 highlighting how attribution and normalization processes sit at the center of a unified architecture that spans in-store, mobile, and external platforms.

In another aspect, the attribution engine 1002, data normalization module 1004, and attribution process 1006 sit at the center of the architecture. The system connects to in-store displays 1008 associated with aisle category targeting 1010, loyalty app notifications 1012, mobile device extensions 1014, and external advertising platforms 1016 such as online retail media, CTV, and social media. Similar to previously described attribution processes, the cross-channel data utilized in attribution algorithms that produce attributed results. The attribution records are stored and processed through a data modeling process 1018 to compensate for behavioral discrepancies between shoppers and estimate the total attributed sales that are then aggregated into aggregated outputs 1020 (by campaign, ad group, product category, or location zone context) and persisted into a reporting database 1022. The econometric results are aggregated and combined with deterministic attribution datapoints to generate holistic performance reports and to inform optimization of future auction bids.

In another aspect, Attribution engine 1002 is the core component of multi-channel advertising strategy 1000. Attribution engine 1002 ingests ad display logs, shopper action events, and POS receipts from in-store environments, as well as engagement and conversion data from external platforms. By joining identifiers across these inputs, attribution engine 1002 produces attribution records that reflect campaign effectiveness across multiple channels.

In another aspect, Data normalization module 1004 is integrated with attribution engine 1002 and harmonizes inputs from heterogeneous sources. Data normalization module 1004 ensures that campaign identifiers, shopper identifiers, and transaction schemas are standardized across in-store, mobile, and external environments. This harmonization enables apples-to-apples comparison of performance data across channels, which is critical for unified reporting.

In another aspect, Attribution process 1006 represents the combined deterministic and econometric methods applied across all channels. Attribution process 1006 incorporates direct shopper linkages (QR scans, coupon redemptions, loyalty IDs) as well as probabilistic causal inference (difference-in-differences, synthetic controls, propensity-score matching). Attribution process 1006 therefore yields a blended set of results that capture both one-to-one attribution and incremental lift.

In another aspect, In-store displays 1008 represent the physical digital screens deployed in aisle-level or zone-level contexts. These displays deliver video advertisements, interactive content, and QR-enabled promotions aligned with product categories. In-store displays 1008 generate impression logs and tracked shopper actions that feed into attribution engine 1002.

In another aspect, Aisle category targeting 1010 defines the contextual mapping between in-store displays 1008 and the product categories they represent. Targeting 1010 ensures that advertisements selected through auctions are directly aligned with the adjacent products, maximizing purchase intent influence.

In another aspect, Loyalty app notifications 1012 represent one mobile extension of the system. Loyalty app notifications 1012 are delivered to shopper devices via retailer loyalty apps, reinforcing in-store exposures with personalized follow-up messages or offers. These notifications are tied to loyalty IDs, enabling deterministic attribution when shoppers redeem offers or complete purchases.

In another aspect, Mobile device extensions 1014 represent additional cross-channel touchpoints, including SMS campaigns, mobile web banners, or push notifications. Mobile device extensions 1014 expand campaign reach beyond in-store displays and loyalty apps, while remaining integrated into the attribution framework through device or loyalty identifiers.

In another aspect, External advertising platforms 1016 include online retail media, connected television, and social media environments. These platforms deliver additional exposures that may influence shopper purchase decisions. External advertising platforms 1016 export engagement and conversion data to attribution engine 1002, allowing the system to compute unified attribution across channels.

In another aspect, Data modeling process 1018 processes attribution records produced by attribution engine 1002. Similar to FIG. 8, data modeling process 1018 applies statistical adjustments to account for behavioral discrepancies across shopper populations and channels. Data modeling process 1018 estimates total attributed sales by extrapolating from observed deterministic signals, ensuring that attribution accounts for shoppers who were influenced but did not engage via trackable identifiers.

In another aspect, Aggregated outputs 1020 roll up attributed results by campaign, ad group, product category, or location zone context across all participating channels. Aggregated outputs 1020 enable advertisers to compare performance not only within a single channel but also across channels, supporting strategic allocation of budget.

In another aspect, Reporting database 1022 stores aggregated outputs 1020 and supports unified analytics dashboards. Reporting database 1022 provides the persistence layer for multi-channel attribution, ensuring that advertisers can access cross-channel performance metrics in real time.

In another aspect, the econometric results produced by attribution process 1006 are aggregated and combined with deterministic datapoints generated by in-store and mobile interactions. These results generate holistic performance reports that provide advertisers with comprehensive, cross-channel views of campaign effectiveness. FIG. 10 therefore, in another aspect, illustrates how attribution engine 1002, data normalization module 1004, and attribution process 1006 sit at the center of a multi-channel strategy that integrates in-store displays 1008, aisle category targeting 1010, loyalty app notifications 1012, mobile device extensions 1014, and external advertising platforms 1016 into a unified framework for reporting and optimization.

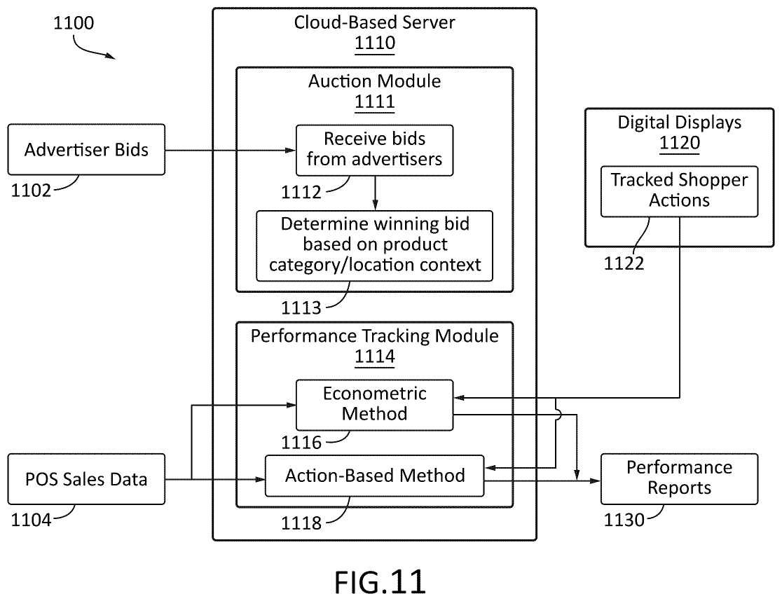

FIG. 11 is a system and process diagram illustration of example advertiser inputs, cloud-based server with an auction module and performance tracking module, in-aisle digital displays associated with product categories or location zone contexts, and performance reports generated from econometric and action-based attribution methods, according to the present disclosure. In particular, in one aspect, FIG. 11 illustrates a digital advertising system 1100 having a plurality of digital displays 1120 positioned within aisles of a physical commercial location. Each digital display of the plurality of digital displays 1120 is associated with at least one of a product category or a location zone context. Shopper interactions with the digital displays of the plurality of digital displays 1120, such as QR scans, coupon redemptions, touch inputs, gaze detections, or voice queries, are recorded as tracked shopper actions 1122.

In another aspect, A cloud-based server 1110 manages advertisement inventory and performance tracking. Within cloud-based server 1110, an auction module 1111 is configured to receive bids from advertisers 1102 for displaying advertisements on the plurality of digital displays 1120. Auction module 1111 determines a winning bid based on the product category or the location zone context 1113, or both, of the display of the plurality of digital displays 1120. The winning advertisement is rendered on the corresponding display of the plurality of digital displays 1120, and the associated winning bid data and impression records are provided to performance tracking module 1114.

In another aspect, Performance tracking module 1114 measures effectiveness of displayed advertisements using two complementary methods. Econometric method 1116 attributes sales to displayed advertisements by analyzing point-of-sale (POS) sales data 1104 and comparing observed outcomes to baseline expectations. Action-based attribution method 1118 attributes sales to displayed advertisements by joining impression logs and winning bid data from auction module 1112 with tracked shopper actions 1122 from the digital display of the plurality of digital displays 1120 and corresponding POS sales data 1104. Together, these methods provide both probabilistic and deterministic measures of advertisement effectiveness.

In another aspect, the results of performance tracking module 1114 are compiled into performance reports 1130, which may include impressions, attributed sales, incremental sales lift, and other campaign effectiveness metrics. Performance reports 1130 may be further utilized by cloud-based server 1110 to inform future auction outcomes, thereby closing the loop between advertisement delivery and measurement.

Accordingly, in another aspect, FIG. 11 demonstrates how advertiser inputs, in-aisle digital displays, tracked shopper actions, POS sales data, and server-side auction and performance tracking modules are integrated into a unified system for real-time targeted advertising and measurement in physical commercial locations.

### IV. Implementations and Examples

In one example, the advertising system displays a scannable offer for an item in the store. This offer activates an add-on item that can be purchased within 30 days, either online or in-store via the retailer's app and offer system. Resulting purchases can be tracked via the action-based attribution method to calculate the total return on investment from both purchases, even though the second purchase might happen after the advertisement was displayed. This measures the full effect and return on investment of the advertisement, something not possible if digital offers are not present.

In another example, Combining the auctioning and targeting system with shopper purchase and preference data, the system can target advertisements or unique offers to shoppers in real time. Using a mobile app connected to the database, shoppers can be identified, and different offers or ads can be displayed based on their personal preferences. Different types of audiences and shoppers can be auctioned at different price points, and the resulting ads are displayed in real time in the store.

In another example, non-transitory computer-readable mediums store program code for executing auction modules, generating holistic performance reports, producing unified analytics dashboards, and tracking user actions. These non-transitory computer-readable mediums may include persistent memory such as flash drives, optical disks, and distributed cloud storage. Instructions stored on the non-transitory computer-readable medium (with instructions) may execute functions such as auction management, analytics generation, and campaign adjustments via the web application (for advertisers to manage campaigns). The integration of non-transitory computer-readable mediums ensures that holistic views, unified analytics, and econometric methods remain consistent across different advertising environments and mediums.

In another example, the system performs aisle category targeting at multiple levels of granularity. An aisle category may include aisle-level categories such as beverages, cleaning supplies, snacks, oral care, health and beauty, or pet products, as well as aisle-specific categories such as seasonal aisles or promotional aisles. Campaigns may be executed simultaneously across multiple aisle categories, and the auction module may leverage aisle-specific categories to refine winning advertisement determinations. In some examples, aisle category targeting is combined with product category, planogram data, and inventory data to maximize contextual relevance. For example, a digital display registered to a beverage aisle category may prioritize bids for soda brands, while a cleaning supplies aisle category may prioritize bids for detergent products. External advertising platforms are integrated deeply into these processes. The system may synchronize with external advertising platforms such as Google Ads™, The Trade Desk™, Meta Ads™, TikTok Ads™, or other third-party demand platforms, ensuring that external advertising platforms ingest in-store campaign data. External advertising platforms may also export campaign results back into the unified analytics dashboard, providing a holistic view of multi-channel advertising strategies. Cross-channel performance metrics may be generated across aisle categories and external advertising platforms. Such cross-channel performance metrics consolidate in-store auction outcomes with online platform data, providing advertisers with consistent insights into campaign effectiveness across different mediums and different advertising environments. These cross-channel performance metrics are integrated into holistic performance reports and unified analytics dashboards, ensuring advertisers can evaluate ROI across multiple aisle categories and multiple channels.

In another example, different mediums are used simultaneously within an aisle category campaign. Different mediums may include static signage, rich video, interactive touchscreen experiences, augmented reality overlays, and audio-enabled displays. These different mediums are coordinated with external advertising platforms to deliver consistent shopper experiences across different advertising environments. The system further tracks user actions across these contexts. Tracking user actions may include screen touches, scrolling, coupon scans, voice commands, dwell times, purchase confirmations, and interactions across loyalty apps or mobile extensions. Tracking user actions in this way ensures that tracked shopper actions provide deterministic attribution signals that can be integrated into econometric methods and holistic performance reports. Advertisement inventory data may also be combined with aisle category targeting. In one example, real-time inventory data feeds may determine whether advertisements for products within a given aisle category are eligible to be served. For example, if an item within a pet food aisle category is out of stock, the auction module may deprioritize campaigns for that item, thereby ensuring that advertisements reflect both aisle category relevance and inventory availability.

In another example, client displays may incorporate an AI shopping assistant interface. Shoppers may engage via natural-language or voice queries (e.g., “What's the best sunscreen for sensitive skin?”). The assistant may return organic recommendations along with sponsored recommendations eligible through the auction module. Shopper queries, taps, and coupon scans are logged as tracked shopper actions, and sponsored responses are attributed deterministically through loyalty IDs or coupon redemption.

In another example, the auction module may function as a distributed auction engine spanning multiple cloud-based servers. The cloud-based server hosts the auction process. The auction process can utilize aisle category information, product category identifiers, and planogram data simultaneously, ensuring that winning bids and winning advertisements reflect both contextual relevance and real-time inventory data. External advertising platforms, including Google Ads™, The Trade Desk™, Meta Ads™, and TikTok Ads™, may be linked directly into the auction module, enabling multi-channel advertising strategies that integrate in-store impressions with external campaign demand.

In another example, the system generates holistic performance reports as part of unified analytics dashboards. These holistic performance reports provide a holistic view of campaign effectiveness across different mediums and different advertising environments and are hosted on a cloud-based server. Unified analytics combine econometric methods, action-based attribution methods, and tracked shopper actions to correlate auction module outcomes with real-world sales lift. Advertisers may review these holistic performance reports to understand performance across aisle categories and multi-channel advertising strategies, ensuring consistent evaluation across all channels.

In another example, the system may further employ econometric attribution methods based on causal inference (e.g., difference-in-differences, synthetic controls, propensity-score matching) that estimate incremental sales impact of advertisement exposures, even in the absence of direct shopper actions.

In another example, shopper interactions are monitored by tracking user actions including screen touches, coupon redemptions, voice commands, scrolling, and subsequent purchase behavior. These tracked shopper actions are correlated with auction process data and unified with shopping behavior data, such as average scan rates, to model and measure deterministically attributed sales and purchases to advertisement exposure.

In another example, shopper interactions are monitored by tracking user actions including screen touches, coupon redemptions, voice commands, scrolling, and subsequent purchase behavior. These tracked shopper actions are correlated with auction process data and unified with shopping behavior data, such as average scan rates, to model and measure deterministically attributed sales and purchases to advertisement exposure.

In another example, action-based attribution (QR scans and coupon redemptions) and econometric causal inference (incremental lift relative to baseline sales) may be combined in a single report. The econometric method provides probabilistic causal lift, while the action-based method provides deterministic 1:1 attributed metrics. Together, these attribution methods yield a comprehensive picture of campaign performance. Holistic performance reports may include impressions, auction win rate, attributed units, incremental sales lift (absolute and percentage), cost-per-purchase, ROAS/ACOS, new-to-brand percentages, and confidence intervals for lift estimates. Reports may further display heterogeneous treatment effects (HTEs) across stores, categories, or screens.

In another example, a salsa brand campaign in a condiments aisle may record 50,000 impressions, 1,250 QR scans, 500 coupon redemptions, and 800 attributed purchases within a seven-day attribution window. Of these purchases, the econometric causal-inference method estimates that 740 represent incremental sales above baseline. At an average unit price of $4.99, total sales revenue equals $3,992. With campaign spend of $1,500, the following results are reported:
Deterministic (action-based) attribution: 500 coupon redemptions are directly tied to ad exposures, producing $2,495 in deterministically attributed revenue. Cost-per-purchase is $3.00 ($1,500÷500), ROAS is 1.66×($2,495÷$1,500), and 40% (200 units) are flagged as new-to-brand based on loyalty history.
Econometric (causal-inference) attribution: 740 incremental purchases are estimated above baseline, producing $3,688 in incremental sales revenue. Cost-per-incremental-purchase is $2.03 ($1,500÷740), and ROAS is 2.46×($3,688÷$1,500), with confidence intervals reported (e.g., 740±60 incremental units).

In another example, this dual attribution framework allows deterministic action-based attribution to capture high-confidence, last-touch shopper actions while econometric methods estimate total incremental lift caused by the campaign, including non-action purchases.

In another example, attributed metrics are joined with unified cross-platform attribution and analytics in order to provide advertising measurement across advertising mediums. By tracking user actions across different mediums and external advertising platforms, the system reinforces ad measurement capabilities and integrates results into holistic performance reports. This enables advertisers to view both deterministic and econometric outcomes side by side, mirroring online reporting paradigms while uniquely extending them into the in-store retail environment.

In another example, attributed metrics are joined with unified cross-platform attribution and analytics in order to provide advertising measurement across advertising mediums. By tracking user actions across different mediums and external advertising platforms, the system reinforces ad measurement capabilities and integrates results into holistic performance reports.

It should be emphasized that the above-described examples of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### V. Embodiment Clauses

Clause 1. A digital advertising system for a physical commercial location, comprising: a. a plurality of digital displays located within aisles of a physical commercial location, each digital display of the plurality of digital displays associated with at least one of: a product category or a location zone context; and b. a cloud-based server configured to manage advertisement inventory and performance tracking, the cloud-based server comprising; i. an auction module configured to: A. receive bids from advertisers for displaying advertisements on the plurality of digital displays; and B. determine a winning bid based on the product category or the location zone context, or both, of a digital display of the plurality of digital displays; and ii. a performance tracking module configured to: A. implement an econometric method for attributing sales to displayed advertisements; and B. implement an action-based attribution method using tracked shopper actions.
Clause 2. The digital advertising system of clause 1, wherein an association between the digital display of the plurality of digital displays and the product category is generated and maintained using inventory data, location metadata, retailer-defined configurations, or automated detection methods, or any combination thereof, and is updatable in response to changes in contextual factors, with such association being managed manually or automatically, or both.
Clause 3. The digital advertising system of clause 1, wherein the performance tracking module is further configured to compare results of the econometric method and the results of the action-based attribution method, and to generate performance metrics comprising incremental sales lifts and engagement rates, for optimizing future auction bids.
Clause 4. The digital advertising system of clause 1, wherein the action-based attribution method comprises: a. tracking user actions; and b. attributing sales resulting from these tracked actions to corresponding advertisements.
Clause 5. The digital advertising system of clause 1, further comprising an optimization engine configured to: a. process algorithms and rules for advertisement selection and delivery; and b. incorporate artificial intelligence and machine learning techniques to enhance ad relevance and effectiveness based on historical performance data and real-time shopper behavior associated with the product category or the location zone context.
Clause 6. The digital advertising system of clause 1, wherein the plurality of digital displays are further configured to: a. display product reviews; b. provide navigation directions within a specific location; c. showcase product demonstrations; and d. present detailed product information associated with the product category or the location zone context.
Clause 7. The digital advertising system of clause 1, further comprising a web application configured to: a. allow advertisers to create, manage, and monitor ad campaigns; b. provide real-time updates on campaign performance; and c. enable dynamic adjustment of bids and ad content based on performance data at a product category level or at a location zone context level.
Clause 8. The digital advertising system of clause 1, wherein the performance tracking module is further configured to: a. integrate performance data from the plurality of digital displays with performance data from other advertising channels; b. generate comprehensive, cross-channel performance metrics that combine results from multiple advertising efforts; and c. provide unified analytics that allow advertisers to compare and optimize performance across various advertising environments.
Clause 9. The digital advertising system of clause 8, wherein the comprehensive, cross-channel performance metrics include: a. total reach across multiple advertising channels; b. combined conversion rates from the displayed advertisements across different mediums; c. comparative return on ad spend (ROAS) for various advertising channels; and d. customer journey analysis incorporating interactions at aisle-level product category touchpoints.
Clause 10. The digital advertising system of clause 1, wherein the cloud-based server is further configured to: a. receive performance data from external advertising platforms; b. correlate this external performance data with advertisement performance data from the plurality of digital displays at various locations; and c. generate holistic performance reports that provide insights into efficacy of multi-channel advertising strategies.
Clause 11. The digital advertising system of clause 1, wherein the product category or the location zone context, or both, are derived from product merchandising data.
Clause 12. A method for delivering targeted advertisements in aisles of a physical commercial location, comprising: a. receiving notification that a digital display in a location zone is available for advertising; b. initiating an auction process for an available display by determining relevant advertisements based on at least one of: a product category or a location zone context, derived from planogram data, inventory data, manual input data, or merchandising data, or any combination thereof, c. selecting a winning advertisement based on bid amount and relevance to the product category or the location zone context, or both; d. displaying the winning advertisement on the available display; and e. tracking performance of the winning advertisement using both an econometric method for attributing sales and an action-based attribution method.
Clause 13. The method of clause 12, further comprising: a. calculating advertising performance results based on the tracked performance; and b. using the tracked performance results to modify future auction bids and win rates for the product category or the location zone context.
Clause 14. The method of clause 13, further comprising: a. collecting performance data from other advertising channels related to same products or categories as the targeted advertisements displayed in the aisles of the physical commercial location; b. combining this external performance data with the tracked performance of in-store advertisements; and c. generating integrated performance reports that provide a holistic view of advertising effectiveness across multiple channels.
Clause 15. A non-transitory computer-readable medium storing instructions that, when executed by a processor, cause the processor to perform a method for digital advertising in aisles of a physical commercial location, the method comprising: a. managing an inventory of advertisements for display on digital screens located in aisles of a physical commercial location; b. conducting real-time auctions for available ad space on the digital screens, based on at least one of: a product category or a location zone context, derived from planogram data, inventory data, manual input data, or merchandising data, or any combination thereof, c. delivering winning advertisements to appropriate digital screens; d. tracking advertisement performance using both an econometric method for attributing sales and an action-based attribution method; and e. providing performance analytics to advertisers for optimizing future campaigns.
Clause 16. The non-transitory computer-readable medium of clause 15, wherein the method further comprises: a. integrating performance data from various advertising platforms with tracked performance from the digital screens located at various locations; b. generating unified performance metrics that combine results from multiple advertising efforts; and c. providing advertisers with comprehensive analytics that allow for optimization across different advertising environments.

It should be emphasized that the above-described embodiment clauses of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A digital advertising system for a physical commercial location, comprising:
a. a plurality of digital displays located within aisles of a physical commercial location, each digital display of the plurality of digital displays associated with at least one of: a product category or a location zone context; and
b. a cloud-based server configured to manage advertisement inventory and performance tracking, the cloud-based server comprising;
i. an auction module configured to:
A. receive bids from advertisers for displaying advertisements on the plurality of digital displays; and
B. determine a winning bid based on the product category or the location zone context, or both, of a digital display of the plurality of digital displays; and
ii. a performance tracking module configured to:
A. implement an econometric method for attributing sales to displayed advertisements; and
B. implement an action-based attribution method using tracked shopper actions.

2. The digital advertising system of claim 1, wherein an association between the digital display of the plurality of digital displays and the product category is generated and maintained using inventory data, location metadata, retailer-defined configurations, or automated detection methods, or any combination thereof, and is updatable in response to changes in contextual factors, with such association being managed manually or automatically, or both.

3. The digital advertising system of claim 1, wherein the performance tracking module is further configured to compare results of the econometric method and the results of the action-based attribution method, and to generate performance metrics comprising incremental sales lifts and engagement rates, for optimizing future auction bids.

4. The digital advertising system of claim 1, wherein the action-based attribution method comprises:
a. tracking user actions; and
b. attributing sales resulting from these tracked actions to corresponding advertisements.

5. The digital advertising system of claim 1, further comprising an optimization engine configured to:
a. process algorithms and rules for advertisement selection and delivery; and
b. incorporate artificial intelligence and machine learning techniques to enhance ad relevance and effectiveness based on historical performance data and real-time shopper behavior associated with the product category or the location zone context.

6. The digital advertising system of claim 1, wherein the plurality of digital displays are further configured to:
a. display product reviews;
b. provide navigation directions within a specific location;
c. showcase product demonstrations; and
d. present detailed product information associated with the product category or the location zone context.

7. The digital advertising system of claim 1, further comprising a web application configured to:
a. allow advertisers to create, manage, and monitor ad campaigns;
b. provide real-time updates on campaign performance; and
c. enable dynamic adjustment of bids and ad content based on performance data at a product category level or at a location zone context level.

8. The digital advertising system of claim 1, wherein the performance tracking module is further configured to:
a. integrate performance data from the plurality of digital displays with performance data from other advertising channels;
b. generate comprehensive, cross-channel performance metrics that combine results from multiple advertising efforts; and
c. provide unified analytics that allow advertisers to compare and optimize performance across various advertising environments.

9. The digital advertising system of claim 8, wherein the comprehensive, cross-channel performance metrics include:
a. total reach across multiple advertising channels;
b. combined conversion rates from the displayed advertisements across different mediums;
c. comparative return on ad spend (ROAS) for various advertising channels; and
d. customer journey analysis incorporating interactions at aisle-level product category touchpoints.

10. The digital advertising system of claim 1, wherein the cloud-based server is further configured to:
a. receive performance data from external advertising platforms;
b. correlate this external performance data with advertisement performance data from the plurality of digital displays at various locations; and
c. generate holistic performance reports that provide insights into efficacy of multi-channel advertising strategies.

11. The digital advertising system of claim 1, wherein the product category or the location zone context, or both, are derived from product merchandising data.

12. A method for delivering targeted advertisements in aisles of a physical commercial location, comprising:
a. receiving notification that a digital display in a location zone is available for advertising;
b. initiating an auction process for an available display by determining relevant advertisements based on at least one of: a product category or a location zone context, derived from planogram data, inventory data, manual input data, or merchandising data, or any combination thereof,
c. selecting a winning advertisement based on bid amount and relevance to the product category or the location zone context, or both;
d. displaying the winning advertisement on the available display; and
e. tracking performance of the winning advertisement using both an econometric method for attributing sales and an action-based attribution method.

13. The method of claim 12, further comprising:
a. calculating advertising performance results based on the tracked performance; and
b. using the tracked performance results to modify future auction bids and win rates for the product category or the location zone context.

14. The method of claim 13, further comprising:
a. collecting performance data from other advertising channels related to same products or categories as the targeted advertisements displayed in the aisles of the physical commercial location;
b. combining this external performance data with the tracked performance of in-store advertisements; and
c. generating integrated performance reports that provide a holistic view of advertising effectiveness across multiple channels.

15. A non-transitory computer-readable medium storing instructions that, when executed by a processor, cause the processor to perform a method for digital advertising in aisles of a physical commercial location, the method comprising:
a. managing an inventory of advertisements for display on digital screens located in aisles of a physical commercial location;
b. conducting real-time auctions for available ad space on the digital screens, based on at least one of: a product category or a location zone context, derived from planogram data, inventory data, manual input data, or merchandising data, or any combination thereof,
c. delivering winning advertisements to appropriate digital screens;
d. tracking advertisement performance using both an econometric method for attributing sales and an action-based attribution method; and
e. providing performance analytics to advertisers for optimizing future campaigns.

16. The non-transitory computer-readable medium of claim 15, wherein the method further comprises:
a. integrating performance data from various advertising platforms with tracked performance from the digital screens located at various locations;
b. generating unified performance metrics that combine results from multiple advertising efforts; and
c. providing advertisers with comprehensive analytics that allow for optimization across different advertising environments.
